(19) United States
(12) Patent Application Publication
(10) Pub. No.: US 2026/0339235 A1
(43) Pub. Date: Oct. 29, 2026

(54) IMAGE FORMING APPARATUS

(71) Applicant: CANON KABUSHIKI KAISHA, Tokyo (JP)

(72) Inventor: Yasuaki Matsumoto, Kanagawa (JP)

(21) Appl. No.: 19/567,586

(22) Filed: Mar. 16, 2026

(30) Foreign Application Priority Data
Apr. 26, 2025 (JP) 2025-073790

(51) Int. Cl. G03G 15/08; G03G 21/16; G03G 21/18

(52) U.S. Cl. CPC G03G 15/0879; G03G 15/0865; G03G 15/0891; G03G 21/1619; G03G 21/1814; G03G 21/1857

(57) ABSTRACT

An image forming apparatus includes a main assembly, a process cartridge detachably mountable to the main assembly and provided with a photosensitive drum and a developing unit, a toner cartridge detachably mountable to the main assembly independently from the process cartridge and provided with an accommodating portion to accommodate toner, a passage to communicate with both the process cartridge and the toner cartridge, through which the toner supplied from the toner cartridge to the developing unit passes. As viewed in a first direction perpendicular to a rotational axis of the photosensitive drum, the toner cartridge is disposed so that at least a part of the accommodating portion is overlapped with the process cartridge. As viewed in a second direction perpendicular to the rotational axis and perpendicular to the first direction, at least a part of the passage is provided so as to be overlapped with the accommodating portion.

### BACKGROUND

### Field of the Technology

The present invention relates to an image forming apparatus using an electrophotographic type such as a printer, a copy machine, and a facsimile device, or a multifunction machine provided with a plurality of functions thereof.

### Description of the Related Art

In an image forming apparatus using an electrophotographic type, a configuration, in which a photosensitive member and a process means such as a developing device for performing an electrophotographic process by acting on the photosensitive member are integrally made into a process cartridge which is detachably mountable to a main assembly, is used.

In addition, for example, in a high-speed image forming apparatus often used for mass printing application, running cost is regarded as important. Therefore, a configuration in which a process cartridge, and a toner cartridge accommodating toner to be supplied to the process cartridge are made independently detachably mountable to a main assembly may be used (Japanese Patent Application Laid-Open No. 2022-075503).

Such a configuration is excellent in terms of the running cost in a case in which mass printing is performed, etc. since in a case in which the toner in the process cartridge is depleted, etc., only the toner cartridge may be replaced while the process cartridge remains mounted to the main assembly.

### SUMMARY

According to an aspect of the present invention, there is provided an image forming apparatus for forming an image on a sheet, the image forming apparatus comprising: a main assembly; a process cartridge detachably mountable to the main assembly and provided with a photosensitive drum rotatable about a rotational axis thereof and a developing unit configured to supply toner to the photosensitive drum and to form a toner image on the photosensitive drum; a toner cartridge detachably mountable to the main assembly independently from the process cartridge and provided with an accommodating portion configured to accommodate the toner; and a passage configured to communicate with both the process cartridge and the toner cartridge, through which the toner supplied from the toner cartridge to the developing unit passes, wherein as viewed in a first direction perpendicular to the rotational axis, the toner cartridge is disposed so that at least a part of the accommodating portion is overlapped with the process cartridge, and wherein as viewed in a second direction perpendicular to the rotational axis and perpendicular to the first direction, at least a part of the passage is provided so as to be overlapped with the accommodating portion.

Further features of the present invention will become apparent from the following description of exemplary embodiments with reference to the attached drawings.

### BRIEF DESCRIPTION OF THE DRAWINGS

FIG. 1 is a cross-sectional outline view of an image forming apparatus in an Embodiment 1.

FIG. 2 is a perspective view of a process cartridge in the Embodiment 1.

FIG. 3 is a perspective view of a toner cartridge in the Embodiment 1.

FIG. 4 is a perspective view illustrating a toner supplying passage in the Embodiment 1.

FIG. 5, part (a) and part (b), includes schematic views for describing arrangement of a toner conveyance pipe in the Embodiment 1.

FIG. 6 is a cross-sectional outline view of an image forming apparatus in a Modified Example.

FIG. 7 is a cross-sectional outline view of an image forming apparatus in a Modified Example.

FIG. 8 is a cross-sectional outline view of an image forming apparatus in a Modified Example.

FIG. 9 is a cross-sectional outline view of an image forming apparatus in an Embodiment 2.

FIG. 10 is a perspective view illustrating a toner supplying passage in the Embodiment 2.

FIG. 11 is a cross-sectional outline view of an image forming apparatus in an Embodiment 3.

FIG. 12 is a perspective view of a process cartridge in the Embodiment 3.

FIG. 13 is a perspective view of a toner cartridge in the Embodiment 3.

FIG. 14 is a perspective view illustrating a toner supplying passage in the Embodiment 3.

FIG. 15 is a cross-sectional outline view of an image forming apparatus in an Embodiment 4.

FIG. 16 is a perspective view illustrating a toner supplying passage in the Embodiment 4.

### DESCRIPTION OF THE EMBODIMENTS

Hereinafter, an image forming apparatus according to the present invention will be described in more detail with reference to the drawings.

### Embodiment 1

### Outline configuration of an image forming apparatus

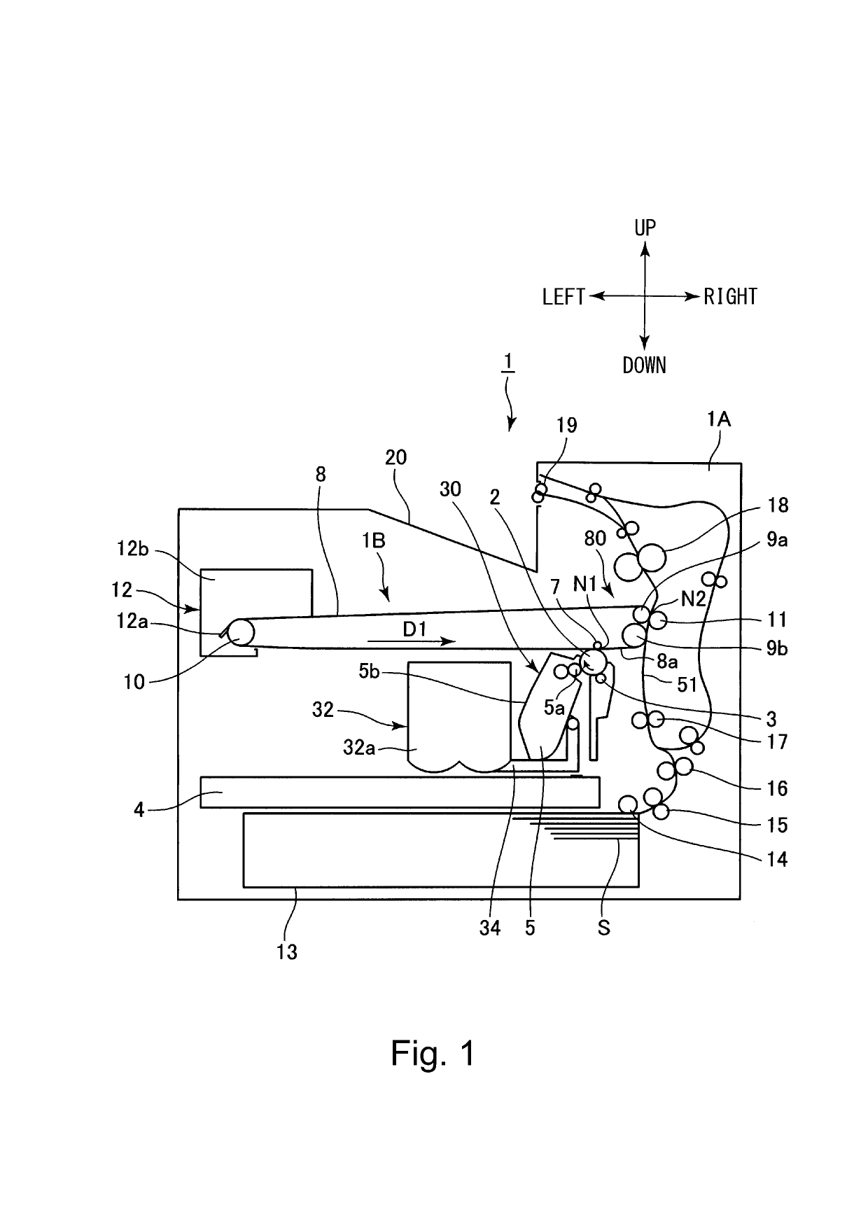

FIG. 1 is a cross-sectional outline view of an image forming apparatus 1 in the present Embodiment. The image forming apparatus 1 in the present Embodiment is a printer employing an intermediary transfer type which forms an image on a sheet S, which is a recording material (recording medium, transfer material) having a sheet shape, using an electrophotographic type and outputs the sheet S as a product. Incidentally, as the sheet S, various sheet material of which sizes and material are different, such as paper such as a plain paper and a thick paper, a plastic film, cloth, sheet material to which surface treatment is applied such as a coated paper, and sheet material having a special shape such as an envelope and index paper, may be used.

Here, the image forming apparatus 1 will be described assuming that the image forming apparatus 1 is installed and used on a horizontal plane. Arrangement and orientation, etc. of the image forming apparatus 1 and elements thereof described below are arrangement and orientation in the case in which the image forming apparatus 1 is installed on the horizontal plane. With respect to the image forming apparatus 1 and the elements thereof, a front side of a paper of FIG. 1 is defined as a “front (front surface)” side, a back side of the paper of FIG. 1 is defined as a “back (back surface)” side, a right side in FIG. 1 is defined as a “right” side, and a left side in FIG. 1 is defined as a “left” side. In the present Embodiment, a direction (front-back direction), which is perpendicular to the paper of FIG. 1 and connecting the front side and the back side of the image forming apparatus 1, is assumed to be parallel to a rotational axis direction of a photosensitive drum 2, which will be described below, and rotational axis directions of stretching rollers for an intermediary transfer belt 8, which will be described below. In addition, an up-down direction refers to up and down in a direction of gravity (vertical direction), however, it does not mean only directly above and directly below, but includes an upside and a downside of a horizontal plane passing through a position and/or an element of interest.

The image forming apparatus 1 includes, inside a main assembly 1A, an image forming portion 1B which forms the image using the electrophotographic type. The image forming portion 1B includes an intermediary transfer belt 8 as an intermediary transfer member, a process cartridge 30, a toner cartridge 32, and a scanner unit (exposure unit) 4 as an exposure means.

The process cartridge 30 is a cartridge which performs image formation using toner. The process cartridge 30 includes a photosensitive drum 2 which is a photosensitive member (electrophotographic photosensitive member) having a drum shape as an image bearing member which bears a toner image, a charging roller 3 which is a charging member having a roller shape as a charging means, and a developing unit (developing device) 5 as a developing means. The photosensitive drum 2 is rotatable about a rotational axis thereof. The process cartridge 30 is detachably mountable to the main assembly 1A. The developing unit 5 includes a developing container 5b, which accommodates the toner as developer, and a developing roller 5a as a developer carrying member (developing member) which is rotatably held by the developing container 5b and rotated with carrying the toner. In the present Embodiment, the process cartridge 30 forms, using toner of black color, the toner image for recording the image on the sheet S on the photosensitive drum 2. In this manner, in the present Embodiment, in the image forming apparatus 1, a process unit including the photosensitive drum 2 and the developing unit 5 is configured to be detachably mountable to the main assembly 1A as the process cartridge 30.

The toner cartridge 32 is a cartridge which accommodates the toner for supply. The toner cartridge 32 includes an accommodating portion (toner container) 32a which accommodates the toner to be supplied to the process cartridge 30. In the present Embodiment, inside the accommodating portion 32a, the toner of black color is accommodated. The toner cartridge 32 is, independently of the process cartridge 30, detachably mountable to the main assembly 1A. The toner cartridge 32 is connected to the process cartridge 30 via a toner conveyance pipe 34 provided to the main assembly 1A. In other words, the toner conveyance pipe 34 as a passage, through which the toner supplied from the toner cartridge 32 to the developing unit 5 passes, is connected to both the process cartridge 30 and the toner cartridge 32. A toner supplying passage from the toner cartridge 32 to the process cartridge 30 will be described below.

Incidentally, the “main assembly 1A” of the image forming apparatus 1 indicates a portion excluding the process cartridge 30 and the toner cartridge 32 from the image forming apparatus 1. The main assembly 1A includes a frame member such as a metal frame member constituting a frame of the image forming apparatus 1, a member fixed to the frame member of the image forming apparatus 1, etc., and forms a mounting space in which the process cartridge 30 and the toner cartridge 32 are mounted.

Inside the main assembly 1A, below the process cartridge 30 and the toner cartridge 32, the scanner unit 4 is disposed. In addition, below the scanner unit 4, a cassette (sheet tray, storage) 13 as a sheet accommodating portion (sheet feeding portion, sheet stacking portion), in which the sheets S used for the image formation are stacked and accommodated, is disposed. The cassette 13 is capable of being drawn out from and inserted into the main assembly 1A. The cassette 13 is capable of accommodating the sheets S in a bundle in which a plurality of the sheets S are piled. Incidentally, in the present Embodiment, an attaching and detaching direction (drawing-out direction and inserting direction) of the cassette 13 with respect to the main assembly 1A is a direction of the rotational axis of the photosensitive drum 2 inside the main assembly 1A. In other words, in the present Embodiment, the cassette 13 is attached to and detached from the main assembly 1A along the front-back direction.

The intermediary transfer belt 8 is constituted by a movable (rotatable) endless belt. The intermediary transfer belt 8 is stretched by a driving roller 9a, a pre-secondary transfer roller 9b, and a tension roller 10 as a plurality of stretching rollers. The driving roller 9a, the pre-secondary transfer roller 9b, and the tension roller 10 are rotated about rotational axes thereof, which are parallel to each other, respectively. The intermediary transfer belt 8 is rotated (circularly moved), by a driving force being transmitted by the driving roller 9a being rotationally driven by a driving force transmitted from a motor (not shown) as a driving source, in a counterclockwise direction in FIG. 1. In other words, the intermediary transfer belt 8 is stretched by the plurality of stretching rollers and conveyed in the counterclockwise direction in FIG. 1. The tension roller 10 applies a tensile force to the intermediary transfer belt 8. In addition, between the tension roller 10 and the pre-secondary transfer roller 9b, an image transfer surface 8a, which is a surface in the intermediary transfer belt 8 to which the toner image is transferred, is formed. In the present Embodiment, the image transfer surface 8a in the intermediary transfer belt 8 is disposed horizontally. On an inner peripheral surface side of the intermediary transfer belt 8, at a position opposite to the photosensitive drum 2 across the intermediary transfer belt 8, a primary transfer roller 7, which is a primary transfer member having a roller shape as a primary transfer means (transfer device), is disposed. The primary transfer roller 7 is pressed toward the photosensitive drum 2, and forms a primary transfer portion (primary transfer nip portion) N1 which is a contacting portion between the photosensitive drum 2 and the intermediary transfer belt 8. On an outer peripheral surface side of the intermediary transfer belt 8, at a position opposite to the driving roller 9a across the intermediary transfer belt 8, a secondary transfer roller 11 which is a secondary transfer member having a roller shape as a secondary transfer means is disposed. The driving roller 9a also serves as an opposite member (opposite electrode) for the secondary transfer roller 11. The secondary transfer roller 11 is pressed toward the driving roller 9a, and forms a secondary transfer portion (secondary transfer nip portion) N2 which is a contacting portion between the intermediary transfer belt 8 and the secondary transfer roller 11. The intermediary transfer belt 8, the primary transfer roller 7, and the secondary transfer roller 11 constitute a transfer unit 80 for transferring the toner image formed on the photosensitive drum 2 to the sheet S. The stretching rollers other than the driving roller 9a, the primary transfer roller 7, and the secondary transfer roller 11 are driven to rotat by the rotation of the intermediary transfer belt 8, respectively.

On the outer peripheral surface side of the intermediary transfer belt 8, at a position opposite to the tension roller 10 across the intermediary transfer belt 8, a belt cleaner 12 as a cleaning means which cleans the intermediary transfer belt 8 is disposed. The belt cleaner 12 includes a cleaning member 12a, which removes adhering material such as transfer residual toner from the surface (the outer peripheral surface) of the intermediary transfer belt 8, and a waste toner container 12b as a collecting container, which collects the adhering material which has been removed from the surface of the intermediary transfer belt 8 by the cleaning member 12a. The cleaning member 12a is constituted by a blade, a brush, etc., which is disposed so as to be in contact with the intermediary transfer belt 8.

Inside the main assembly 1A, above the secondary transfer portion N2, a fixing device 18 as a fixing means is disposed. In the present Embodiment, the fixing device 18 has a configuration of a heat fixing type which performs fixing of the toner image by heating. The fixing device 18 includes, for example, a fixing roller and a pressing roller which nip and convey the sheet S, and a heat source (for example, a halogen lamp) which heats the toner image on the sheet S via the fixing roller.

### Image forming operation

In a case in which the image forming apparatus 1 executes an image forming operation, the sheet S is fed from the cassette 13 at a lower portion of the main assembly 1A by a feeding roller 14 which is a sheet feeding member as a sheet feeding means. In addition, the sheets S are separated one by one,and conveyed by a separating roller pair 15 which is a separating member as a separating means. The sheet S is conveyed, by a pulling-out roller 16, toward a registration roller pair 17 which is a sheet conveyance member as a sheet conveyance means. The sheet S is conveyed along a guide member 51 which regulates (guides) a moving direction of the sheet S. Of the sheet S, oblique movement is corrected by a leading end thereof being abutted against the registration roller pair 17 (or a shutter member provided in a vicinity of the registration roller pair 17). And the sheet S is sent to the secondary transfer portion N2 by the registration roller pair 17 at a timing synchronized with a progress of a toner image forming process by the image forming portion 1B.

On the other hand, in the image forming portion 1B, the photosensitive drum 2 is rotated in a clockwise direction in FIG. 1 by a driving force transmitted from a motor (not shown) as a driving source provided to the main assembly 1A. A surface (outer peripheral surface) of the rotating photosensitive drum 2 is uniformly charged to a predetermined potential of predetermined polarity (negative polarity in the present Embodiment) by the charging roller 3. During charging process, to the charging roller 3, by a charging power source as a charging voltage applying portion provided to the main assembly 1A, a charging voltage (charging bias) having the same polarity as the charging polarity of the photosensitive drum 2 is applied. The charged surface of the photosensitive drum 2 is scanned and exposed by the scanner unit 4, and an electrostatic latent image (electrostatic image) is formed on the photosensitive drum 2. The scanner unit 4 irradiates, based on image information representing the image to be recorded on the sheet S, the photosensitive drum 2 with laser light, and writes the electrostatic latent image onto the photosensitive drum 2. The electrostatic latent image formed on the photosensitive drum 2 is developed (visualized) by the toner being supplied by the developing unit 5, and the toner image (developer image) is formed on the photosensitive drum 2. In the present Embodiment, the developing unit 5 uses toner which is a non-magnetic one-component developer as the developer, supplies the toner to the electrostatic latent image on the photosensitive drum 2 with the developing roller 5a provided so as to be in contact with the surface of the photosensitive drum 2, and forms the toner image on the photosensitive drum 2. The developing roller 5a is rotated by a driving force transmitted from a motor (not shown) as a driving source provided to the main assembly 1A, carries the toner on a surface (outer peripheral surface) thereof, and conveys the toner toward the photosensitive drum 2. In addition, during development, to the developing roller 5a, by a developing power source as a developing voltage applying portion provided to the main assembly 1A, a developing voltage (developing bias) having the same polarity as the charging polarity of the photosensitive drum 2 is applied. In the present Embodiment, to an exposed portion on the photosensitive drum 2, in which an absolute value of potential is decreased by being exposed after having been uniformly charged, the developing unit 5 causes the toner, which is charged to the same polarity as the charging polarity of the photosensitive drum 2 (negative polarity in the present Embodiment), to be adhered (reverse development type). In the present Embodiment, the normal charging polarity of the toner, which is a main charging polarity of the toner during development, is negative polarity.

The toner image formed on the photosensitive drum 2 is, at the primary transfer portion N1, by an action of the primary transfer roller 7, transferred (primarily transferred) onto the intermediary transfer belt 8 as a rotating transferred member. During primary transfer, to the primary transfer roller 7, by a primary transfer power source as a primary transfer voltage applying portion provided to the main assembly 1A, a primary transfer voltage (primary transfer bias) having polarity opposite to the normal charging polarity of the toner (positive polarity in the present Embodiment) is applied. The toner image transferred onto the intermediary transfer belt 8 is conveyed toward the secondary transfer portion N2 by the rotation of the intermediary transfer belt 8.

And the toner image on the intermediary transfer belt 8 is, at the secondary transfer portion N2, by an action of the secondary transfer roller 11, transferred (secondarily transferred) onto the sheet S as a transferred member which is being nipped and conveyed between the intermediary transfer belt 8 and the secondary transfer roller 11. During secondary transfer, to the secondary transfer roller 11, by a secondary transfer power source as a secondary transfer voltage applying portion provided to the main assembly 1A, a secondary transfer voltage (secondary transfer bias) having polarity opposite to the normal charging polarity of the toner (positive polarity in the present Embodiment) is applied. The driving roller 9a is electrically grounded (connected to a ground potential).

Incidentally, the image forming apparatus 1 may have a configuration in which a secondary transfer voltage having the same polarity as the normal charging polarity of the toner is applied to a roller corresponding to the driving roller 9a in the present Embodiment, and a member corresponding to the secondary transfer roller 11 in the present Embodiment is electrically grounded.

The sheet S which has passed through the secondary transfer portion N2 is sent to the fixing device 18. And, while the sheet S passes through a nip portion between the fixing roller and the pressing roller, the toner image is heated and pressed. As a result, the toner is softened, and thereafter, by the toner being sticked onto the sheet S, the image is fixed to the sheet S. The sheet S which has passed through the fixing device 18 is discharged (output) from the main assembly 1A by a discharging roller pair 19, which is a sheet discharging member as a sheet discharging means, and is stacked as a product on a stacking tray 20 as a sheet discharging portion, which is provided at an upper portion of the main assembly 1A.

In addition, adhering material such as the transfer residual toner remaining on the intermediary transfer belt 8 during secondary transfer are removed from the intermediary transfer belt 8 and collected by the belt cleaner 12. In addition, the transfer residual toner remaining on the photosensitive drum 2 during primary transfer is collected by the developing unit 5. Incidentally, a drum cleaner as a cleaning means which cleans the photosensitive drum 2 may be provided. In that case, the drum cleaner may be incorporated in the process cartridge 30.

### The process cartridge and the toner cartridge

The cartridges to be mounted to the image forming apparatus 1 in the present Embodiment will be described. As described above, in the image forming apparatus 1, the process cartridge 30, which forms the image using the toner, and the toner cartridge 32, which accommodates the toner for supply, are detachably mountable to the main assembly 1A independently of each other.

When the toner in the developing unit 5 in the process cartridge 30 decreases by repeating the image forming operation, via the toner supplying passage, which will be described below, the toner is supplied from the toner cartridge 32 to the developing unit 5. For example, it may be configured that as the toner in the developing unit 5 is consumed, sequentially, the toner is supplied from the toner cartridge 32 to the developing unit 5. In addition, for example, it may be configured that when the toner in the developing unit 5 decreases to a predetermined amount (for example, in a case in which the toner in the developing unit 5 substantially runs out), the toner is supplied from the toner cartridge 32 to the developing unit 5.

When replenishment of the toner to the image forming apparatus 1 is performed (typically, when the toner in the toner cartridge 32 substantially runs out), it is sufficient to replace the toner cartridge 32 while the process cartridge 30 remains mounted to the main assembly 1A. Incidentally, when the photosensitive drum 2, etc. in the process cartridge 30 reaches an end of life, it is sufficient to replace the process cartridge 30.

### Arrangement of the cartridges

Next, arrangement of the process cartridge 30 and the toner cartridge 32 in the present Embodiment will be described.

Here, among the plurality of stretching rollers which stretch the intermediary transfer belt 8, a direction in which the intermediary transfer belt 8 is moved from the tension roller 10 as a first stretching roller toward the pre-secondary transfer roller 9b as a second stretching roller is defined as a “conveyance direction D1” of the intermediary transfer belt 8. In other words, the conveyance direction D1 of the intermediary transfer belt 8 is a moving direction of the image transfer surface 8a of the intermediary transfer belt 8. In the present Embodiment, the conveyance direction D1 of the intermediary transfer belt 8 is a horizontal direction.

In the present Embodiment, as shown in FIG. 1, the process cartridge 30 and the toner cartridge 32 are lined up along (in the present Embodiment, in parallel with) the conveyance direction D1 of the intermediary transfer belt 8.

Specifically, the process cartridge 30 is disposed below the intermediary transfer belt 8 so that the photosensitive drum 2 is in contact with the image transfer surface 8a of the intermediary transfer belt 8 (outer peripheral surface of the intermediary transfer belt 8). The rotational axis direction of the photosensitive drum 2 is parallel to a width direction of the intermediary transfer belt 8 (rotational axis direction of the primary transfer roller 7), which is perpendicular to the conveyance direction D1 of the intermediary transfer belt 8. On the other hand, the toner cartridge 32 is disposed below the intermediary transfer belt 8 along (in the present Embodiment, in parallel with) the conveyance direction D1 of the intermediary transfer belt 8 and lined up with the process cartridge 30.

In addition, in the present Embodiment, the process cartridge 30 is disposed on a downstream side in the conveyance direction D1 of the intermediary transfer belt 8 with respect to the toner cartridge 32. In other words, in the present Embodiment, the process cartridge 30 is disposed, in a rotational direction of the intermediary transfer belt 8, on the downstream side of the toner cartridge 32 and on an upstream side of the secondary transfer portion N2 (driving roller 9a). In addition, the toner cartridge 32 is disposed, in the rotational direction of the intermediary transfer belt 8, on the downstream side of the belt cleaner 12 (tension roller 10) and on the upstream side of the process cartridge 30. This is advantageous in shortening a waiting time (First Print-Out Time) from input of a job to the image forming apparatus 1 until the image is formed on a first sheet S and discharged from the image forming apparatus 1.

In addition, in the present Embodiment, the process cartridge 30 and the toner cartridge 32 are disposed, in a direction perpendicular to the conveyance direction D1 of the intermediary transfer belt 8 as viewed in the rotational axis direction of the photosensitive drum 2, between the scanner unit 4 and the intermediary transfer belt 8, respectively. In addition, in the present Embodiment, as viewed in the direction perpendicular to the conveyance direction D1 of the intermediary transfer belt 8 as viewed in the rotational axis direction of the photosensitive drum 2, as for the process cartridge 30 and the toner cartridge 32, at least a part thereof is overlapped with the intermediary transfer belt 8, respectively. In addition, in the present Embodiment, as viewed in the direction perpendicular to the conveyance direction D1 of the intermediary transfer belt 8 as viewed in the rotational axis direction of the photosensitive drum 2, as for the process cartridge 30 and the toner cartridge 32, at least a part thereof is overlapped with the scanner unit 4, respectively. In addition, in the present Embodiment, as viewed in the direction perpendicular to the conveyance direction D1 of the intermediary transfer belt 8 as viewed in the rotational axis direction of the photosensitive drum 2, as for the process cartridge 30 and the toner cartridge 32, at least a part thereof is overlapped with the cassette 13, respectively.

And at least a part of the accommodating portion 32a of the toner cartridge 32 is, as viewed in the conveyance direction D1 of the intermediary transfer belt 8, overlapped with the process cartridge 30. In other words, as viewed in the conveyance direction D1 of the intermediary transfer belt 8, an occupation range of the process cartridge 30 and an occupation range of the accommodating portion 32a of the toner cartridge 32 are at least partially overlapped with each other. In particular, in the present Embodiment, in the rotational axis direction of the photosensitive drum 2, a length of the accommodating portion 32a of the toner cartridge 32 is approximately the same as a length of the process cartridge 30. Therefore, in an approximately entire area of the accommodating portion 32a of the toner cartridge 32 in the rotational axis direction of the photosensitive drum 2, as viewed in the conveyance direction D1 of the intermediary transfer belt 8, at least a part of the accommodating portion 32a is overlapped with the process cartridge 30. Incidentally, in the rotational axis direction of the photosensitive drum 2, the length of the process cartridge 30 is equal to or longer than a length of the photosensitive drum 2.

In this manner, as viewed in a first direction perpendicular to the rotational axis direction of the photosensitive drum 2, the toner cartridge 32 is disposed so that at least a part of the accommodating portion 32a is overlapped with the process cartridge 30. In other words, the toner cartridge 32 and the process cartridge 30 are lined up in the first direction. In the present Embodiment, the first direction is a direction crossing the direction of gravity, and in particular, is the horizontal direction.

Incidentally, in the present Embodiment, the attaching and detaching direction (a mounting direction and a removing direction) of the process cartridge 30 to the main assembly 1A is the direction of the rotational axis of the photosensitive drum 2 in the main assembly 1A. In other words, in the present Embodiment, the process cartridge 30 is attached to and detached from the main assembly 1A along the front-back direction. In addition, in the present Embodiment, the attaching and detaching direction (mounting direction and removing direction) of the toner cartridge 32 to the main assembly 1A is the direction of the rotational axis of the photosensitive drum 2 in the main assembly 1A. In other words, in the present Embodiment, the toner cartridge 32 is attached to and detached from the main assembly 1A along the front-back direction. To a side portion on the front side of the image forming apparatus 1, a door (not shown) as an opening/closing member which opens an inside of the main assembly 1A so as to enable the attaching and detaching of the process cartridge 30 and the toner cartridge 32 is provided. By opening the door, and operating the process cartridge 30 and the toner cartridge 32 by hand, respectively, a user may attach and detach these cartridges with respect to the main assembly 1A. To the main assembly A, attaching and detaching guide members which regulate (guide) moving directions during attaching and detaching of the process cartridge 30 and the toner cartridge 32, and positioning members which determine positions of the process cartridge 30 and the toner cartridge 32 may be provided. The process cartridge 30 and the toner cartridge 32 are connected, by being mounted to the main assembly 1A, to the toner conveyance pipe 34, respectively.

### Toner supplying passage

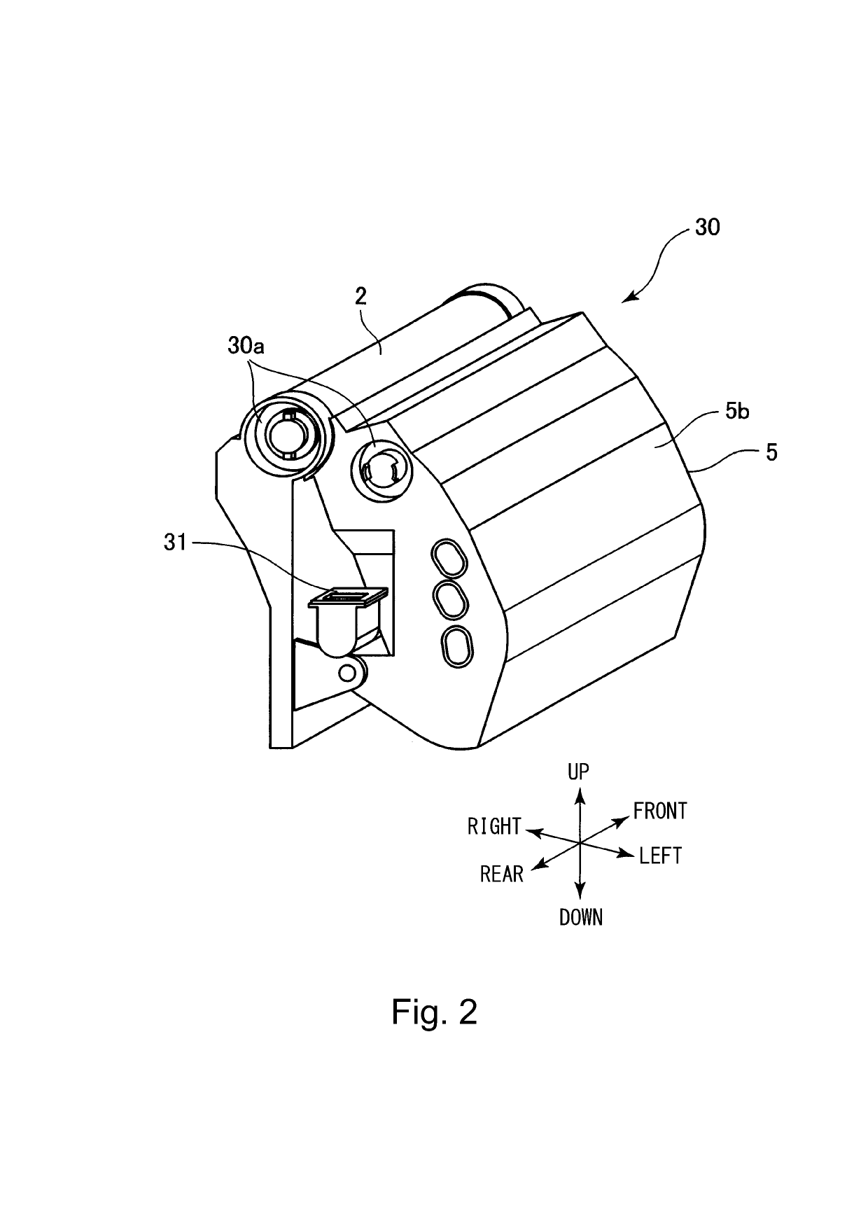

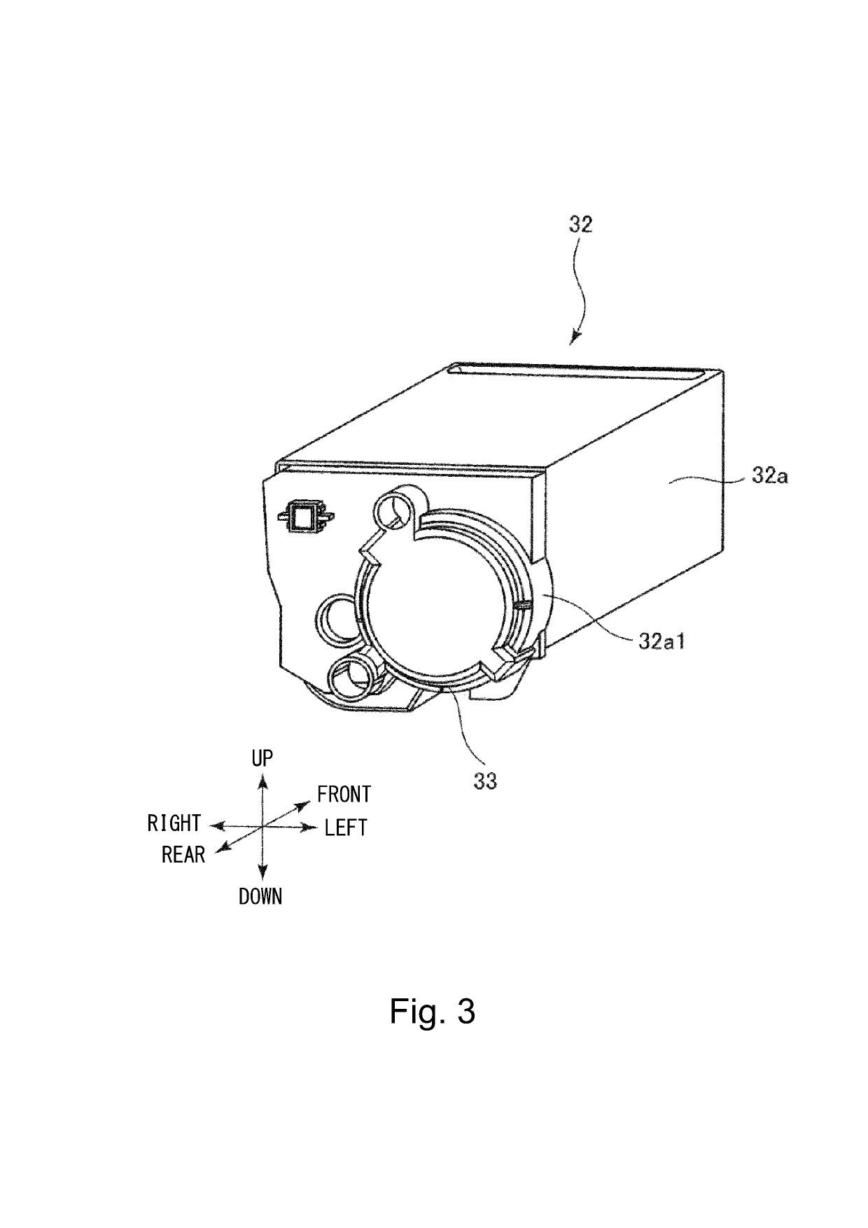

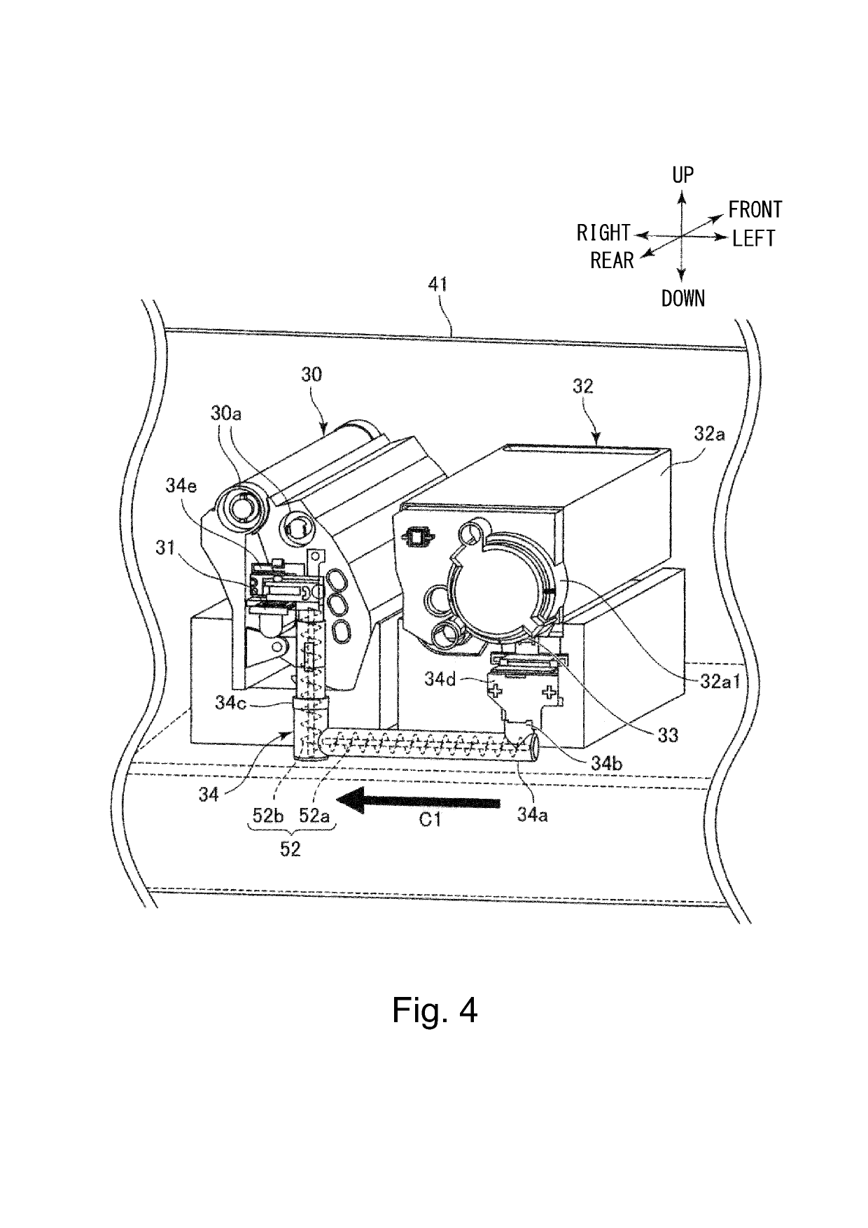

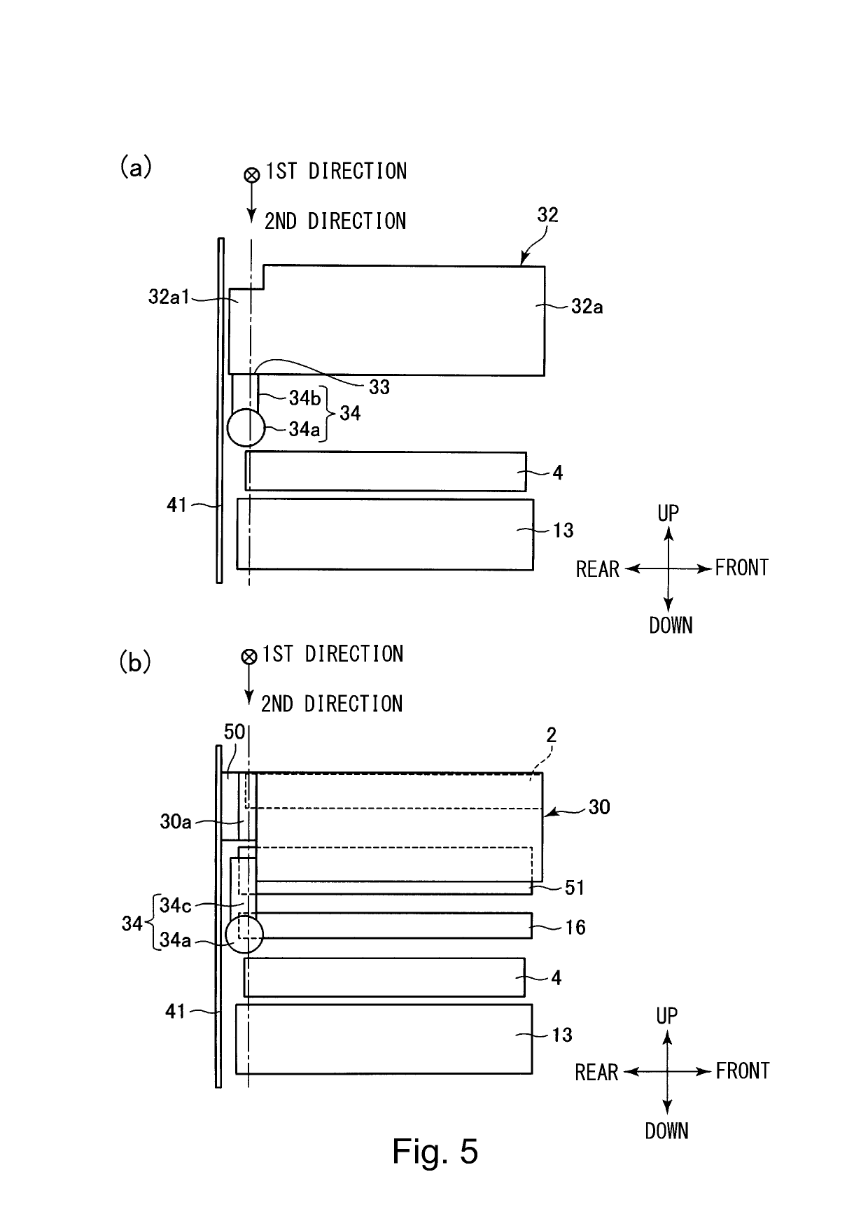

Next, the toner supplying passage from the toner cartridge 32 to the process cartridge 30 in the present Embodiment will be described. FIG. 2 is a perspective view of the process cartridge 30 in the present Embodiment. FIG. 3 is a perspective view of the toner cartridge 32 in the present Embodiment. FIG. 4 is a perspective view illustrating the toner conveyance pipe 34 which connects the toner cartridge 32 and the process cartridge 30 in the present Embodiment. FIG. 2 through FIG. 4 all illustrate states viewed from the back side of the image forming apparatus 1 (the back side of the paper of FIG. 1). In addition, part (a) and part (b) of FIG. 5 are schematic views of a vicinity of the toner conveyance pipe 34 as viewed from the toner cartridge 32 side along the direction (first direction) in which the toner cartridge 32 and the process cartridge 30 are lined up. Part (a) of FIG. 5 illustrates a positional relationship, etc. between the toner conveyance pipe 34 and the toner cartridge 32, and part (b) of FIG. 5 illustrates a positional relationship, etc. between the toner conveyance pipe 34 and the process cartridge 30.

As shown in FIG. 2, in the process cartridge 30, to an end portion on the back side thereof, a supply port 31, which is an opening portion for supplying the toner, is provided. The supply port 31 constitutes a receiving portion for receiving the toner which has passed through the toner conveyance pipe 34 into the developing unit 5. In the present Embodiment, the supply port 31 is provided to a side portion on the back side of the process cartridge 30. The supply port 31 communicates with a space in the developing container 5b of the developing unit 5 in the process cartridge 30. In addition, in the present Embodiment, the supply port 31 opens upward.

On the other hand, as shown in FIG. 3, in the toner cartridge 32, to an end portion on the back side thereof, a discharging port 33, which is an opening portion for discharging the toner, is provided. The discharging port 33 constitutes a discharging portion for discharging the toner accommodated in the accommodating portion 32a from the accommodating portion 32a. In the present Embodiment, the discharging port 33 is provided to a side portion on the back side of the toner cartridge 32. The discharging port 33 communicates with a space in the accommodating portion 32a of the toner cartridge 32. In the present Embodiment, the discharging port 33 is provided on a bottom surface side (downside) of the toner cartridge 32. In addition, in the present Embodiment, the discharging port 33 opens downward. In the present Embodiment, the accommodating portion 32a of the toner cartridge 32 includes, at an end portion on the back side thereof, a projecting portion 32a1 projected to the back side. In the present Embodiment, the discharging port 33 is provided on a bottom surface of this projecting portion 32a1. By the discharging port 33 being provided on the bottom surface side of the toner cartridge 32, it becomes possible to efficiently discharge the toner in the direction of gravity. Therefore, it is effective to fully discharge the toner in the toner cartridge 32.

And, as shown in FIG. 4, the supply port 31 of the process cartridge 30 is connected, via the toner conveyance pipe 34 provided to the main assembly 1A, to the discharging port 33 of the toner cartridge 32.

The toner conveyance pipe 34 is extended downward from a portion which is connected to the discharging port 33 provided on the bottom surface side of the toner cartridge 32. In addition, the toner conveyance pipe 34 is extended, along (in the present Embodiment, in parallel with) the direction in which the toner cartridge 32 and the process cartridge 30 are lined up, toward the process cartridge 30 side passing through a downside of the toner cartridge 32. And the toner conveyance pipe 34 is extended, from an end portion of the portion extended toward the process cartridge 30 side, upward toward the process cartridge 30, and is connected to the supply port 31 of the process cartridge 30.

To describe further, the toner conveyance pipe 34 includes a first part 34a extended along the conveyance direction D1 of the intermediary transfer belt 8. In addition, the toner conveyance pipe 34 includes a second part 34b extended upward toward the discharging port 33 side of the toner cartridge 32 from an end portion of the first part 34a on the toner cartridge 32 side. In addition, the toner conveyance pipe 34 includes a third part 34c extended upward toward the supply port 31 side of the process cartridge 30 from an end portion of the first part 34a on the process cartridge 30 side. In addition, in the present Embodiment, to an end portion of the second part 34b on a side opposite to the first part 34a, a receiving portion 34d which receives the toner discharged from the discharging port 33 of the toner cartridge 32 is provided. Incidentally, illustration is omitted for simplicity, however, in the present Embodiment, between the discharging port 33 and the receiving portion 34d, a sealing member, etc. for suppressing the toner from leaking from a gap between the discharging port 33 and the receiving portion 34d are provided. In addition, in the present Embodiment, to an end portion of the third part 34c on a side opposite to the first part 34a, a supply portion 34e for discharging the toner, which has passed through the toner conveyance pipe 34, toward the supply port 31 is provided. In the present Embodiment, the supply portion 34e is provided so as to be extended along the conveyance direction D1 of the intermediary transfer belt 8 from the third part 34c toward the supply port 31. In addition, between the supply portion 34e and the supply port 31, a sealing member, etc. for suppressing the toner from leaking from a gap between the supply port 31 and the supply portion 34e may be provided.

And, at least a part of the toner conveyance pipe 34 is provided, as viewed in a second direction perpendicular to the rotational axis direction of the photosensitive drum 2 and perpendicular to the first direction, which is the direction in which the toner cartridge 32 and the process cartridge 30 are lined up, so as to be overlapped with the accommodating portion 32a of the toner cartridge 32 (FIG. 4, part (a) of FIG. 5). In particular, at least a part of the first part 34a of the toner conveyance pipe 34, which is extended between the toner cartridge 32 and the process cartridge 30 along the first direction, is overlapped with the accommodating portion 32a (particularly, the projecting portion 32a1) of the toner cartridge 32 as viewed in the second direction. In the present Embodiment, the second direction is a direction crossing the horizontal direction, and in particular, is the direction of gravity. In other words, in the present Embodiment, when the toner cartridge 32 is viewed from an upper surface side, at least a part of the toner conveyance pipe 34 is disposed at a position overlapped with the toner cartridge 32.

The toner conveyance pipe 34 is disposed on a front side of a backside plate 41, which is one of the frame members of the main assembly 1A. The backside plate 41 is disposed, on the back side of the main assembly 1A, parallel to the up-down direction and the left-right direction, respectively (parallel to the paper of FIG. 1). In other words, the backside plate 41 is provided on a downstream side of the main assembly 1A in the mounting direction of the process cartridge 30 and the toner cartridge 32 to the main assembly 1A, and the toner conveyance pipe 34 is provided on an upstream side of the backside plate 41 in the mounting direction. Incidentally, in FIG. 4, the toner conveyance pipe 34, etc. are illustrated in a manner to be seen through a surface of the backside plate 41, and only a part of an edge of the backside plate 41 is illustrated.

To describe further, as shown in part (a) of FIG. 5, at least a part of the toner conveyance pipe 34 is provided so as to be at the same position as the accommodating portion 32a of the toner cartridge 32 in the rotational axis direction of the photosensitive drum 2 (front-back direction). In the present Embodiment, the toner conveyance pipe 34 is provided so that an approximately entirety thereof is overlapped with the accommodating portion 32a of the toner cartridge 32 in the rotational axis direction of the photosensitive drum 2.

In addition, the main assembly 1A includes a drive transmitting portion 50 which transmits a driving force to the process cartridge 30. On the other hand, the process cartridge 30 includes a driving force receiving portion 30a which receives the driving force from the drive transmitting portion 50 by being engaged with the drive transmitting portion 50. The driving force receiving portion 30a transmits the driving force to a driven portion in the process cartridge 30. The driving force receiving portion 30a is constituted by, for example, a coupling, a gear, etc. provided to one end portion (an end portion on the back side in the present Embodiment) of the photosensitive drum 2 and the developing roller 5a in the rotational axis direction of the photosensitive drum 2. Incidentally, the driving force transmitted from the drive transmitting portion 50 to the driving force receiving portion 30a, which is coupled to a driven member (for example, the coupling and/or the gear coupled to the photosensitive drum 2) may be transmitted (branched) to other driven portions (the developing roller 5a, etc.) in the process cartridge 30.

And, as shown in part (b) of FIG. 5, in the present Embodiment, at least a part of the toner conveyance pipe 34 is provided so as to be at the same position as the driving force receiving portion 30a in the rotational axis direction of the photosensitive drum 2 (front-back direction). In the present Embodiment, as viewed in the second direction, at least a part of the toner conveyance pipe 34 is provided so as to be overlapped with the driving force receiving portion 30a. Furthermore, at least a part of the toner conveyance pipe 34 may be provided so as to be at the same position as the photosensitive drum 2 in the rotational axis direction of the photosensitive drum 2.

In addition, as shown in part (a) and part (b) of FIG. 5, in the present Embodiment, at least a part of the toner conveyance pipe 34 is provided so as to be at the same position as the scanner unit 4 in the rotational axis direction of the photosensitive drum 2. In the present Embodiment, as viewed in the second direction, at least a part of the toner conveyance pipe 34 is provided so as to be overlapped with the scanner unit 4. In addition, in the present Embodiment, at least a part of the toner conveyance pipe 34 is provided so as to be at the same position as the cassette 13 in the rotational axis direction of the photosensitive drum 2. In the present Embodiment, as viewed in the second direction, at least a part of the toner conveyance pipe 34 is provided so as to be overlapped with the cassette 13. In addition, in the present Embodiment, at least a part of the toner conveyance pipe 34 is provided so as to be at the same position as the guide member 51 which regulates (guides) the moving direction of the sheet S. In addition, in the present Embodiment, at least a part of the toner conveyance pipe 34 is provided so as to be at the same position as the sheet conveying member such as the pulling-out roller 16 and the registration roller pair 17 which conveys the sheet S along the guide member 51 in the rotational axis direction of the photosensitive drum 2.

Incidentally, in the present Embodiment, positions of the discharging port 33, the toner conveyance pipe 34, and the supply port 31 in the rotational axis direction of the photosensitive drum 2 are approximately the same.

Next, a conveyance passage of the toner will be described. The toner is conveyed from the toner cartridge 32 toward the process cartridge 30 through the toner conveyance pipe 34, and is supplied to the process cartridge 30. Specifically, first, the toner in the toner cartridge 32 is discharged from the discharging port 33, and sent into the toner conveyance pipe 34. In the present Embodiment, the toner falls by utilizing gravity through the discharging port 33, and is moved to the receiving portion 34d of the toner conveyance pipe 34. In addition, the toner falls inside the second part 34b of the toner conveyance pipe 34 by utilizing gravity, and is moved to the first part 34a of the toner conveyance pipe 34. Inside the first part 34a and the third part 34c of the toner conveyance pipe 34, a screw 52, which is a toner conveyance member as a toner conveyance means, is disposed. A first screw 52a is disposed inside the first part 34a, and a second screw 52b is disposed inside the third part 34c. The screw 52 (52a, 52b) is driven by a driving unit (not shown) as a driving means, which is provided to the main assembly 1A. The toner inside the first part 34a of the toner conveyance pipe 34 is conveyed, by the first screw 52a being driven, in a direction of an arrow C1 in FIG. 4. This direction of the arrow C1 is a direction along (in the present Embodiment, a direction parallel to) the conveyance direction D1 of the intermediary transfer belt 8. The toner, which has been conveyed inside the first part 34a of the toner conveyance pipe 34 by the first screw 52a, is conveyed, by the second screw 52b being driven, upward inside the third part 34c of the toner conveyance pipe 34. The toner, which has been conveyed inside the third part 34c of the toner conveyance pipe 34 by the second screw 52b, is sent to the supply port 31 of the process cartridge 30 through the supply portion 34e. And this toner enters an inside of the developing container 5b of the developing unit 5 from the supply port 31. In this manner, the toner is supplied from the toner cartridge 32 to the process cartridge 30.

Here, in the configuration described in Japanese Patent Application Laid-Open No. 2022-075503, a toner conveyance pipe for conveying toner from a toner cartridge to a process cartridge is disposed on a back side of the toner cartridge. In this case, in a main assembly, on the back side of the toner cartridge, a space for providing the toner conveyance pipe is required. Therefore, in a case in which a toner capacity of the toner cartridge is increased, it is necessary to increase a mounting space in which the toner cartridge is mounted while securing a space for the toner conveyance pipe on the back side of the toner cartridge, which results in an increase in size of the image forming apparatus. On the other hand, if the increase in size of the image forming apparatus is to be suppressed, it is necessary to make the toner cartridge smaller, and to accommodate the toner conveyance pipe on the back side of the toner cartridge and the toner cartridge in a limited space.

In the present Embodiment, it is configured that the process cartridge 30 and the toner cartridge 32 are disposed side by side along the conveyance direction D1 of the intermediary transfer belt 8, and the toner conveyance pipe 34 (particularly, the first part 34a) is disposed so as to be overlapped with the downside of the toner cartridge 32. By this, the space for providing the toner conveyance pipe 34 in the main assembly 1A on the back side of the toner cartridge 32 becomes not required. Therefore, it becomes possible to reduce the space, and achieve downsizing of the image forming apparatus 1. Alternatively, since it becomes possible to use the space for the toner cartridge 32, the toner capacity of the toner cartridge may be increased.

In addition, in the present Embodiment, the toner conveyance pipe 34 is disposed on the front side of the backside plate 41. By this, it becomes possible to access the toner conveyance pipe 34 from the front side of the image forming apparatus 1, and it becomes possible to improve maintainability. Here, the access typically means that an operator touches with a hand, a tool, etc., but also includes observing through visual observation, etc. for checking a state, etc. For example, in order to cope with unexpected toner clogging, etc. in the toner conveyance pipe 34, it is conceivable to make the toner conveyance pipe 34 replaceable as a unit. By making the toner conveyance pipe 34 easily accessible as described above, it becomes easier to perform the unit replacement, which leads to improvement of product value in view of serviceability.

### Modified Example

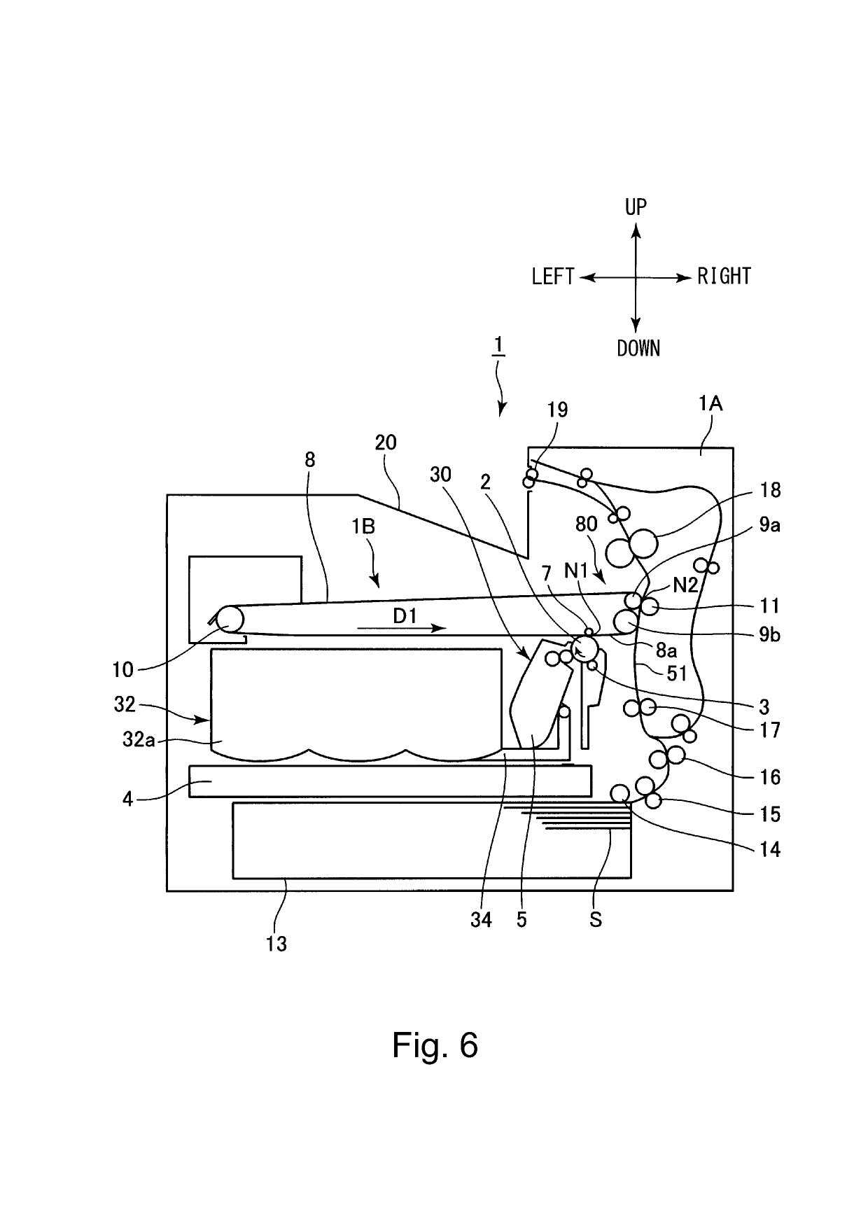

FIG. 6 is a cross-sectional outline view of an image forming apparatus 1 in a Modified Example of the present Embodiment. As shown in FIG. 6, in a case in which there is a margin in a space inside a main assembly 1A, in a toner cartridge 32, an accommodating portion 32a may further be expanded utilizing the space to achieve further increase in a toner capacity. In an example shown in FIG. 6, compared with the configuration in the present Embodiment shown in FIG. 1, a width of the accommodating portion 32a in the toner cartridge 32 in a conveyance direction D1 of an intermediary transfer belt 8 becomes larger.

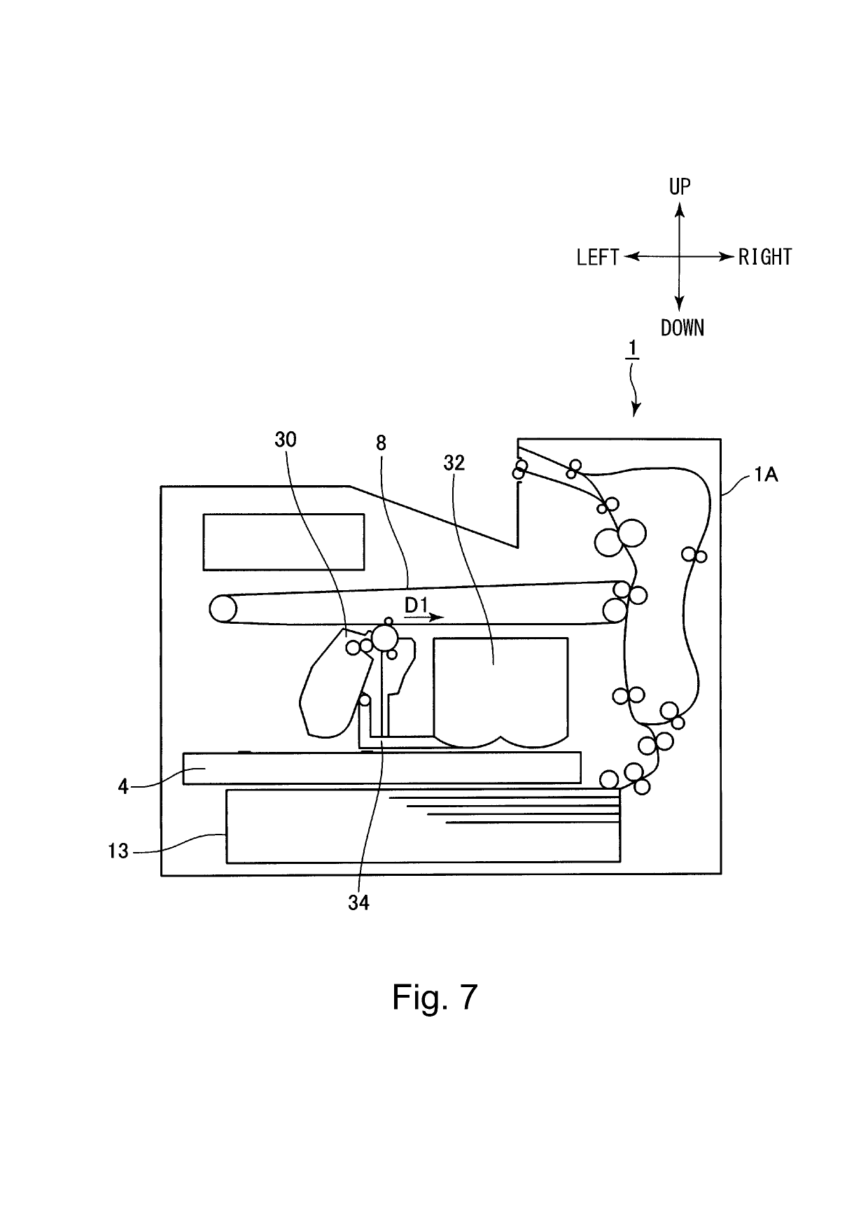

FIG. 7 is a cross-sectional outline view of an image forming apparatus 1 in another Modified Example of the present Embodiment. Arrangement of a process cartridge 30 and a toner cartridge 32 may be changed as appropriate. For example, as shown in FIG. 7, an order in which the process cartridge 30 and the toner cartridge 32 are lined up in a conveyance direction D1 of an intermediary transfer belt 8 may be switched. In addition, as the arrangement of the process cartridge 30 and the toner cartridge 32, arrangement other than the arrangement parallel to the conveyance direction D1 may be employed. For example, it is not limited for the process cartridge 30 and the toner cartridge 32 to be lined up in parallel with the conveyance direction D1 of the intermediary transfer belt 8, but may be disposed to be inclined to the conveyance direction D1 of the intermediary transfer belt 8.

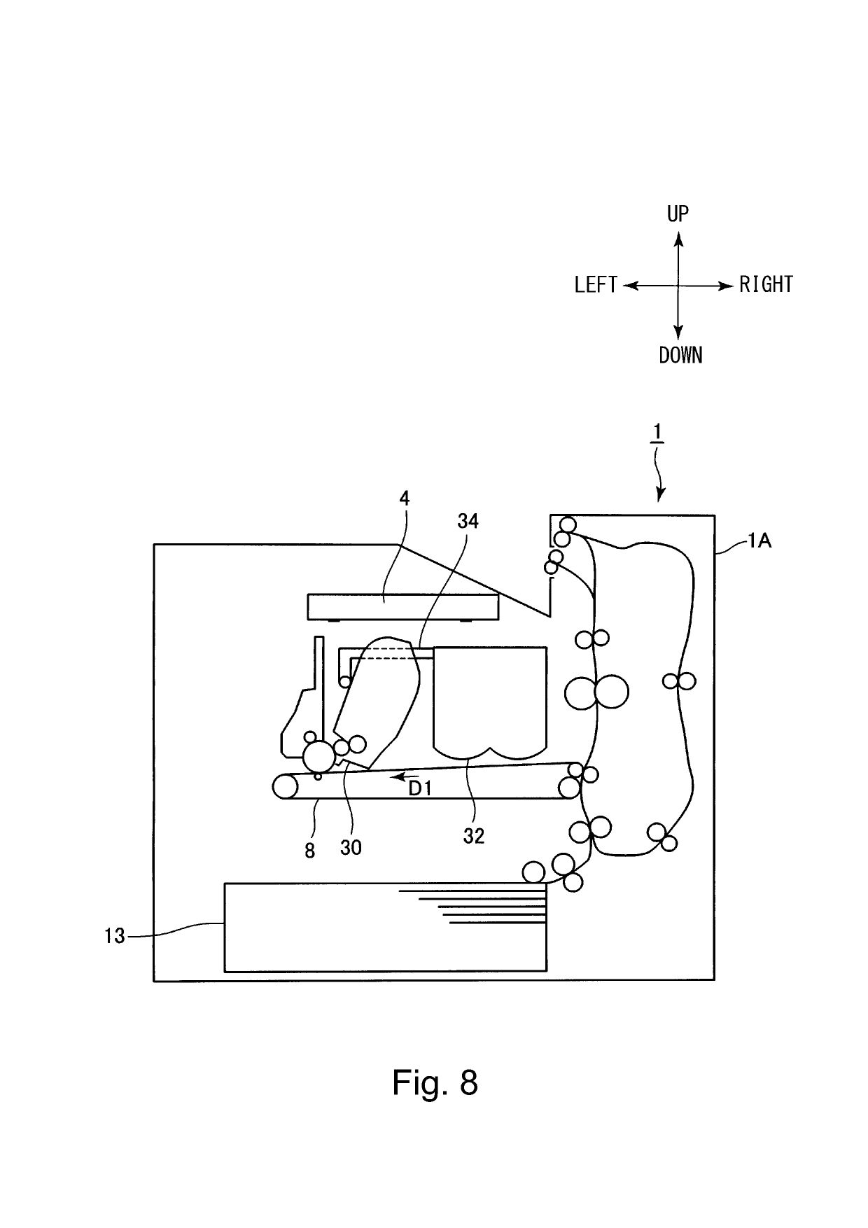

FIG. 8 is a cross-sectional outline view of an image forming apparatus 1 in still another Modified Example of the present Embodiment. In the present Embodiment, the process cartridge 30 and the toner cartridge 32 are disposed below the intermediary transfer belt 8, however, as shown in FIG. 8, these cartridges may be disposed above the intermediary transfer belt 8. In this case as well, a process cartridge 30 and a toner cartridge 32 are lined up along (for example, in parallel with) a conveyance direction D1 of an intermediary transfer belt 8, which is an opposite direction to the present Embodiment. In addition, also in this case, it is preferable that the toner cartridge 32 be disposed on an upstream side of the process cartridge 30 in the conveyance direction D1 of the intermediary transfer belt 8. In addition, in this case, it is preferable that a toner conveyance pipe 34 be disposed at an upper portion of the toner cartridge 32. And, also in this case, by disposing the toner conveyance pipe 34 so as to be overlapped with the upper side of the toner cartridge 32, it becomes possible to obtain an effect similar to the present Embodiment.

In addition, a stretching direction of the intermediary transfer belt 8 is not limited to the horizontal direction, but may be a direction obliquely crossing the horizontal direction as viewed in the rotational axis direction of the photosensitive drum 2, or the vertical direction. Therefore, the conveyance direction D1 of the intermediary transfer belt 8 is not limited to the direction shown in FIG. 1, etc.

In addition, the toner conveyance means is not limited to a screw member, but the toner inside the toner conveyance pipe 34 may be conveyed by any toner conveyance means. For example, as a toner conveyance member as the toner conveyance means, a member capable of mechanically conveying the toner, such as a screw member, a belt member, and a paddle member, may be used alone or in combination arbitrarily. In other words, the toner conveyance member may be at least one of a screw, a belt, and a paddle. In addition, for example, it may be configured that by blowing air inside the toner conveyance pipe 34, the toner is conveyed from the toner cartridge 32 to the process cartridge 30. In this case, as the toner conveyance means, it is sufficient to provide a conveyance mechanism, which is capable of conveying the toner utilizing air pressure such as an air pump, to the main assembly 1A.

In addition, the toner conveyance pipe 34 may be provided so that at least a part thereof is, as viewed in the rotational axis direction of the photosensitive drum 2, overlapped with at least one of the scanner unit 4 and the cassette 13. In this case, the toner conveyance pipe 34 may be laid out in a dead space beside the scanner unit 4 and/or the cassette 13.

### Effect

As described above, according to the present Embodiment, in the configuration in which the process cartridge and the toner cartridge are detachably mountable to the main assembly independently, it becomes possible, while downsizing the image forming apparatus, to increase the toner capacity of the toner cartridge.

### Embodiment 2

Next, another Embodiment of the present invention will be described. Basic configuration and operation of an image forming apparatus in the present Embodiment are the same as those in the Embodiment 1. Therefore, in the image forming apparatus in the present Embodiment, to those elements having functions or configurations which are the same as or corresponding to those of the image forming apparatus in the Embodiment 1, the same reference numerals as in the Embodiment 1 will be attached, and detailed description thereof will be omitted.

### Arrangement of cartridges

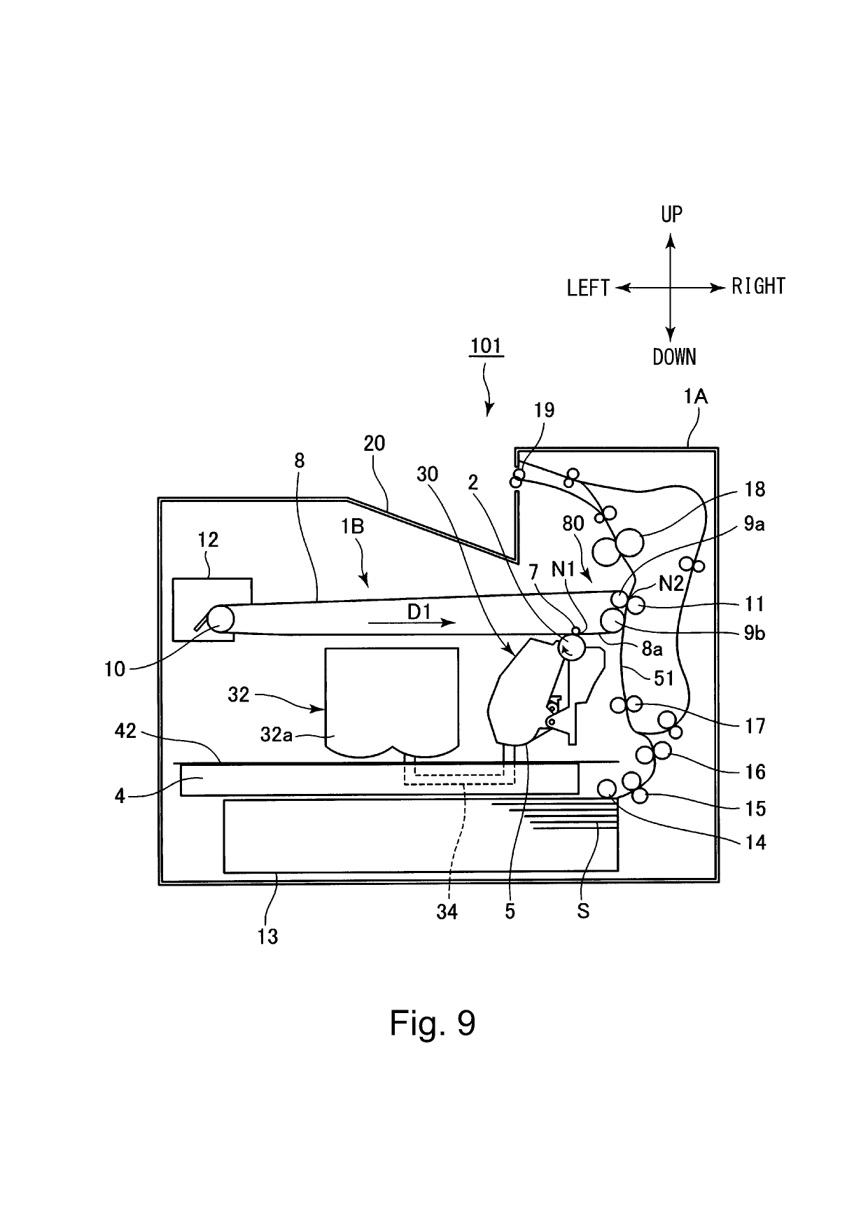

Arrangement of a process cartridge 30 and a toner cartridge 32 in the present Embodiment will be described. FIG. 9 is a cross-sectional outline view of an image forming apparatus 101 in the present Embodiment.

As shown in FIG. 9, in the present Embodiment, similarly to the Embodiment 1, the process cartridge 30 and the toner cartridge 32 are lined up along (in the present Embodiment, in parallel with) a conveyance direction D1 of an intermediary transfer belt 8 and disposed on a downside of the intermediary transfer belt 8. In addition, in the present Embodiment, similarly to the Embodiment 1, the process cartridge 30 is disposed on a downstream side in the conveyance direction D1 of the intermediary transfer belt 8 with respect to the toner cartridge 32. And in the present Embodiment, similarly to the Embodiment 1, at least a part of an accommodating portion 32a of the toner cartridge 32 is overlapped with the process cartridge 30 as viewed in the conveyance direction D1 of the intermediary transfer belt 8.

### Toner supplying passage

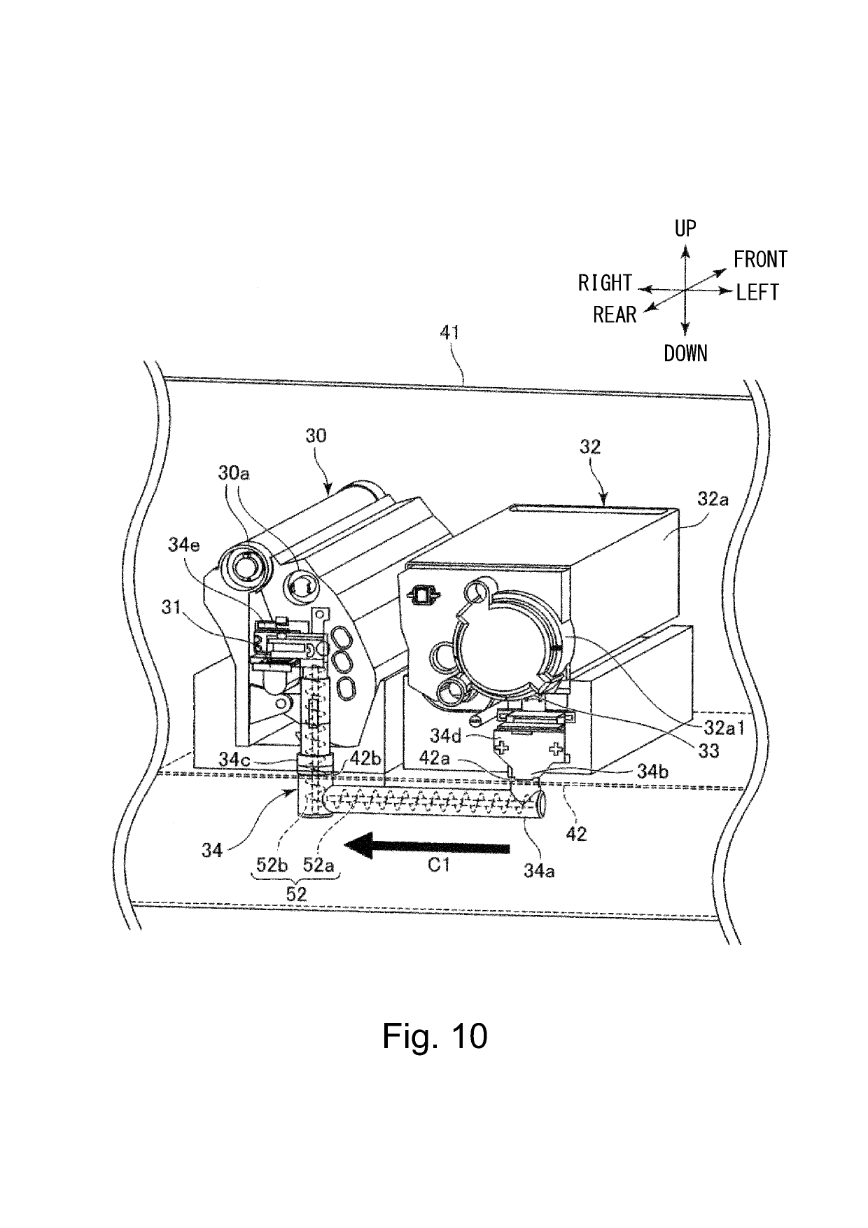

Next, the toner supplying passage from the toner cartridge 32 to the process cartridge 30 in the present Embodiment will be described. FIG. 10 is a perspective view illustrating a toner conveyance pipe 34 which connects the toner cartridge 32 and the process cartridge 30 in the present Embodiment. FIG. 10 illustrates a state as viewed from a back side of the image forming apparatus 101 (back side of a paper of FIG. 9).

As shown in FIG. 10, in the present Embodiment, similarly to the Embodiment 1, in the process cartridge 30, to an end portion on a back side thereof, a supply port 31 is provided. In addition, in the toner cartridge 32, on a bottom surface side of an end portion on a back side, a discharging port 33 is provided. And the supply port 31 of the process cartridge 30 is connected, via the toner conveyance pipe 34 provided to a main assembly 1A, to the discharging port 33 of the toner cartridge 32.

In the present Embodiment, similarly to the Embodiment 1, the toner conveyance pipe 34 includes a first part 34a, a second part 34b, and a third part 34c. In addition, in the present Embodiment, to the toner conveyance pipe 34, a receiving portion 34d and a supply portion 34e are provided.

And similarly to the Embodiment 1, as viewed in the second direction perpendicular to the rotational axis direction of the photosensitive drum 2 and perpendicular to the first direction, which is the direction in which the toner cartridge 32 and the process cartridge 30 are lined up, at least a part of the toner conveyance pipe 34 is provided so as to be overlapped with the accommodating portion 32a of the toner cartridge 32. In particular, at least a part of the first part 34a of the toner conveyance pipe 34 is overlapped with the accommodating portion 32a (particularly, a projecting portion 32a1) of the toner cartridge 32 as viewed in the second direction. In the present Embodiment, the second direction is a direction crossing a horizontal direction, and in particular, is a direction of gravity.

Incidentally, as shown in FIG. 9, in the present Embodiment, the toner conveyance pipe 34 (particularly, the first part 34a) is provided so that at least a part thereof is overlapped with a scanner unit 4 as viewed in a rotational axis direction of a photosensitive drum 2. Further, the toner conveyance pipe 34 may be provided so that at least a part thereof is overlapped with a cassette 13 as viewed in the rotational axis direction of the photosensitive drum 2.

In the present Embodiment, at least a part of the toner conveyance pipe 34 is disposed on a side opposite to the process cartridge 30 and the toner cartridge 32 across a cartridge stay 42, which is one of frame members of the main assembly 1A. In other words, at least a part of the toner conveyance pipe 34 is provided on a side opposite to a side where the process cartridge 30 and the toner cartridge 32 are provided with respect to the cartridge stay 42. The cartridge stay 42 is a frame member which supports the process cartridge 30 and the toner cartridge 32, and is disposed parallel to a front-back direction and a left-right direction, respectively (perpendicular to the paper of FIG. 9). In addition, in the present Embodiment, at least a part of the toner conveyance pipe 34 is attached to the cartridge stay 42.

In other words, in the present Embodiment, the first part 34a of the toner conveyance pipe 34 is disposed on a downside of the cartridge stay 42, and is attached to the cartridge stay 42. In addition, in the present Embodiment, the second part 34b of the toner conveyance pipe 34 is disposed on an upside of the cartridge stay 42, and is attached to the cartridge stay 42. In addition, in the present Embodiment, the third part 34c of the toner conveyance pipe 34 is disposed on the upside of the cartridge stay 42, and is attached to the cartridge stay 42. And, the first part 34a and the second part 34b communicate with each other via a first hole 42a, which is a hole (opening portion) provided in the cartridge stay 42. In other words, the first part 34a is attached to the downside of the cartridge stay 42 so as to be connected to the first hole 42a, and the second part 34b is attached to the upside of the cartridge stay 42 so as to be connected to the first hole 42a. As a result, by the second part 34b of the toner conveyance pipe 34 being extended upward from the first hole 42a of the cartridge stay 42, the discharging port 33 of the toner cartridge 32 and the first part 34a of the toner conveyance pipe 34 are connected. Similarly, the first part 34a and the third part 34c communicate with each other via a second hole 42b, which is a hole (opening portion) provided in the cartridge stay 42. In other words, the first part 34a is attached to the downside of the cartridge stay 42 so as to be connected to the second hole 42b, and the third part 34c is attached to the upside of the cartridge stay 42 so as to be connected to the second hole 42b. As a result, by the third part 34c of the toner conveyance pipe 34 being extended upward from the second hole 42b of the cartridge stay 42, the supply port 31 of the process cartridge 30 and the first part 34a of the toner conveyance pipe 34 are connected. Here, the second part 34b of the toner conveyance pipe 34 may be considered to be configured to include the first hole 42a provided in the cartridge stay 42. In addition, the third part 34c of the toner conveyance pipe 34 may be considered to be configured to include the second hole 42b provided in the cartridge stay 42.

In this way, in the present Embodiment, the first part 34a is positioned on the side opposite to the side where the process cartridge 30 and the toner cartridge 32 are provided with respect to the cartridge stay 42. In addition, in the present Embodiment, the second part 34b is positioned on the side where the process cartridge 30 and the toner cartridge 32 are provided with respect to the cartridge stay 42. And at least a part of the first part 34a is connected to the second part 34b via the first hole 42a as a first opening portion provided in the cartridge stay 42. In addition, in the present Embodiment, the third part 34c is positioned on the side where the process cartridge 30 and the toner cartridge 32 are provided with respect to the cartridge stay 42. And the first part 34a is connected to the third part 34c via the second hole 42b as a second opening portion provided in the cartridge stay 42.

Incidentally, it may be configured that the second part 34b of the toner conveyance pipe 34 is connected, in a manner that the second part 34b is extended and penetrates the first hole 42a provided in the cartridge stay 42, to the discharging port 33 of the toner cartridge 32 and the first part 34a of the toner conveyance pipe 34. Similarly, it may be configured that the third part 34c of the toner conveyance pipe 34 may be connected, in a manner that the third part 34c is extended and penetrates the second hole 42b provided in the cartridge stay 42, to the first part 34a of the toner conveyance pipe 34 and the supply port 31 of the process cartridge 30.

In this manner, in the present Embodiment, the toner conveyance pipe 34 is extended downward from the portion connected to the discharging port 33, which is provided on the bottom surface side of the toner cartridge 32, up to the downside of the cartridge stay 42. In addition, the toner conveyance pipe 34 is extended, along (in the present Embodiment, in parallel with) the direction in which the toner cartridge 32 and the process cartridge 30 are lined up, toward the process cartridge 30 side passing through the downside of the cartridge stay 42. And the toner conveyance pipe 34 is extended upward from an end portion of the portion extending toward the process cartridge 30 side toward the process cartridge 30 up to the upside of the cartridge stay 42, and is connected to the supply port 31 of the process cartridge 30.

In addition, in the present Embodiment, similarly to the Embodiment 1, the toner conveyance pipe 34 is disposed on a front side of a backside plate 41. In addition, in the present Embodiment, the downside of the cartridge stay 42 is an area into which the cassette 13 is inserted, and by pulling out the cassette 13 from the main assembly 1A, the toner conveyance pipe 34 is exposed.

A conveyance passage of toner in the present Embodiment is similar to that in the Embodiment 1. That is, in the present Embodiment, similarly to the Embodiment 1, the toner is discharged from the discharging port 33 of the toner cartridge 32, falls inside the second part 34b of the toner conveyance pipe 34 by utilizing gravity, and is moved to the first part 34a of the toner conveyance pipe 34. The toner inside the first part 34a of the toner conveyance pipe 34 is conveyed by a first screw 52a in a direction of an arrow C1 in FIG. 10. This direction of the arrow C1 is a direction along (in the present Embodiment, a direction parallel to) the conveyance direction D1 of the intermediary transfer belt 8. In addition, the toner inside the third part 34c of the toner conveyance pipe 34 is conveyed upward by a second screw 52b. Thereafter, the toner enters an inside of a developing container 5b of a developing unit 5 from the supply port 31. In this manner, the toner is supplied from the toner cartridge 32 to the process cartridge 30.

In the present Embodiment, it is configured that the process cartridge 30 and the toner cartridge 32 are lined up along the conveyance direction D1 of the intermediary transfer belt 8, and the toner conveyance pipe 34 (particularly, the first part 34a) is disposed so as to be overlapped with a downside of the toner cartridge 32. By this, it becomes possible to obtain an effect similar to the Embodiment 1.

In addition, in the present Embodiment, the toner conveyance pipe 34 (particularly, the first part 34a) is disposed on the opposite side to the process cartridge 30 and the toner cartridge 32 across the cartridge stay 42 (the downside of the cartridge stay 42). The downside of the cartridge stay 42 is the area into which the cassette 13 is inserted. By this, by pulling out the cassette 13 from the main assembly 1A, it becomes possible to easily access the toner conveyance pipe 34 (particularly, the first part 34a) from a front side of the image forming apparatus 101, and it becomes possible to improve maintainability. For example, as described in the Embodiment 1, in a case in which the toner conveyance pipe 34 is configured to be replaceable as a unit, unit replacement thereof becomes easy.

In addition, in the present Embodiment, the toner conveyance pipe 34 is attached to the cartridge stay 42, which supports the process cartridge 30 and the toner cartridge 32. In other words, in the present Embodiment, the toner conveyance pipe 34 is attached to a component common to the process cartridge 30 and the toner cartridge 32. By this, since it becomes possible to reduce dimensions related to the connections between the supply port 31 of the process cartridge 30 and the discharging port 33 of the toner cartridge 32 and the toner conveyance pipe 34, and reduce tolerance variation, it becomes possible to improve accuracy in connected positions.

Incidentally, also in the present Embodiment, a modification similar to the Modified Example to the Embodiment 1 described using FIG. 6 may be applied. In addition, also in the present Embodiment, a modification similar to the Modified Example to the Embodiment 1 described using FIG. 7 may be applied.

In addition, also in the present Embodiment, similar to a modification described as the Modified Example to the Embodiment 1, a stretching direction of the intermediary transfer belt 8 is not limited to the horizontal direction, but may be changed as appropriate.

In addition, also in the present Embodiment, similar to a modification described as the Modified Example to the Embodiment 1, the toner conveyance means is not limited to the screw member, but may be changed as appropriate.

### Embodiment 3

Next, another Embodiment of the present invention will be described. In an image forming apparatus in the present Embodiment, to those elements having functions or configurations which are the same as or corresponding to those of the image forming apparatus in the Embodiment 1, the same reference numerals as in the Embodiment 1 will be attached, and detailed description thereof will be omitted.

### Outline configuration and image forming operation of an image forming apparatus

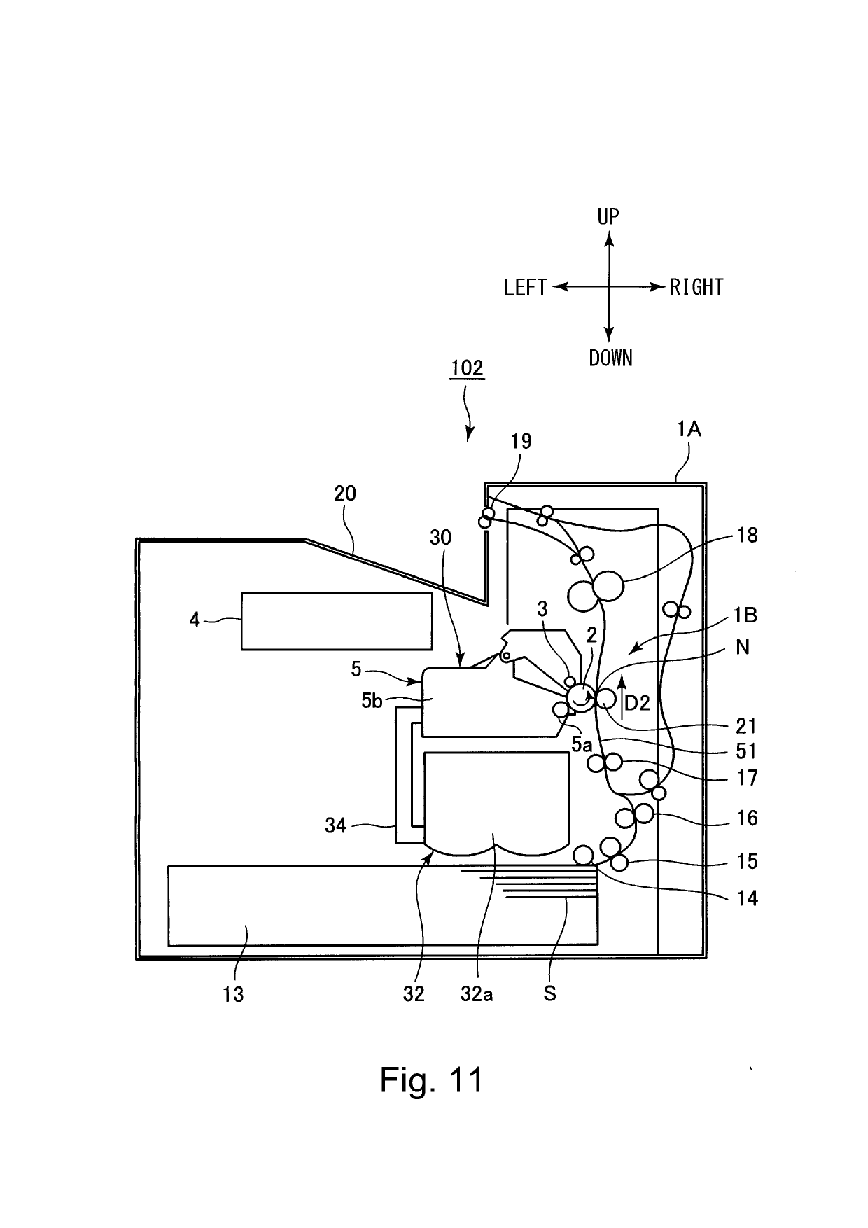

FIG. 11 is a cross-sectional outline view of an image forming apparatus 102 in the present Embodiment. The image forming apparatus 102 in the present Embodiment is different from the image forming apparatus 1 in the Embodiment 1 in the transfer type of the toner image to the sheet S. The image forming apparatus 102 in the present Embodiment is a printer employing a direct transfer type.

In the present Embodiment, the image forming apparatus 102 includes, at a position opposite to a photosensitive drum 2, a transfer roller 21 which is a transfer member having a roller shape as a transfer means (transfer device). The transfer roller 21 is pressed toward the photosensitive drum 2, and forms a transfer portion (transfer nip portion) N, which is a contacting portion between the photosensitive drum 2 and the transfer roller 21.

When the image forming apparatus 102 executes an image forming operation, a sheet S is fed from a cassette 13 at a lower portion of a main assembly 1A, and similarly to the Embodiment 1, the sheet S is sent into the transfer portion N at a timing synchronized with a progress of a toner image forming process by an image forming portion 1B. Incidentally, in the present Embodiment, an attaching and detaching direction of the cassette 13 with respect to the main assembly 1A is a direction of a rotational axis of the photosensitive drum 2 in the main assembly 1A.

On the other hand, in the image forming portion 1B, similarly to the Embodiment 1, a toner image is formed on the photosensitive drum 2. And, in the present Embodiment, the toner image formed on the photosensitive drum 2 is transferred, at the transfer portion N, by an action of the transfer roller 21, to the sheet S as a transferred member which is being nipped and conveyed between the photosensitive drum 2 and the transfer roller 21. During transfer, to the transfer roller 21, by a transfer power source as a transfer voltage applying portion provided to the main assembly 1A, a transfer voltage (transfer bias) having opposite polarity to normal charging polarity of toner (positive polarity in the present Embodiment) is applied. The sheet S which has passed through the transfer portion N is, similarly to the Embodiment 1, sent to a fixing device 18, and after an image is fixed thereto, the sheet S is discharged (output) to an outside of the main assembly 1A.

### The process cartridge and the toner cartridge

Next, cartridges to be mounted to the image forming apparatus 102 in the present Embodiment will be described. In the image forming apparatus 102 in the present Embodiment, similarly to the Embodiment 1, a process cartridge 30, which forms an image using toner of black color, and a toner cartridge 32, which accommodates the toner to be supplied to the process cartridge 30, are detachably mountable to the main assembly 1A independently of each other.

### Arrangement of the cartridges

Next, arrangement of the process cartridge 30 and the toner cartridge 32 in the present Embodiment will be described.

Here, a moving direction of the sheet S at the transfer portion N is defined as a “conveyance direction D2” of the sheet S. In other words, the conveyance direction D2 of the sheet S is the moving direction of the sheet S which is nipped and conveyed between the photosensitive drum 2 and the transfer roller 21. In the present Embodiment, the conveyance direction D2 of the sheet S is a direction of gravity.

In the present Embodiment, as shown in FIG. 11, the process cartridge 30 and the toner cartridge 32 are lined up along (in the present Embodiment, in parallel with) the conveyance direction D2 of the sheet S.

Specifically, the process cartridge 30 is disposed, so that the photosensitive drum 2 is in contact with the transfer roller 21, on a left side of the transfer roller 21. The rotational axis direction of the photosensitive drum 2 is parallel to a width direction of the sheet S (a rotational axis direction of the transfer roller 21), which is perpendicular to the conveyance direction D2 of the sheet S at the transfer portion N. On the other hand, the toner cartridge 32 is disposed, along (in the present Embodiment, in parallel with) the conveyance direction D2 of the sheet S and lined up with the process cartridge 30, on the left side with respect to the transfer roller 21. In addition, in the present Embodiment, the toner cartridge 32 is disposed on an upstream side in the conveyance direction D2 of the sheet S with respect to the process cartridge 30.

And at least a part of an accommodating portion 32a of the toner cartridge 32 is, as viewed in the conveyance direction D2 of the sheet S, overlapped with the process cartridge 30. In other words, as viewed in the conveyance direction D2 of the sheet S, an occupation range of the process cartridge 30 and an occupation range of the accommodating portion 32a of the toner cartridge 32 are at least partially overlapped with each other. In particular, in the present Embodiment, in the rotational axis direction of the photosensitive drum 2, a length of the accommodating portion 32a of the toner cartridge 32 is approximately the same as a length of the process cartridge 30. Therefore, in an approximately entire area of the accommodating portion 32a of the toner cartridge 32 in the rotational axis direction of the photosensitive drum 2, as viewed in the conveyance direction D2 of the sheet S, at least a part of the accommodating portion 32a is overlapped with the process cartridge 30. Incidentally, in the rotational axis direction of the photosensitive drum 2, the length of the process cartridge 30 is equal to or longer than a length of the photosensitive drum 2.

In this manner, as viewed in a first direction perpendicular to the rotational axis direction of the photosensitive drum 2, the toner cartridge 32 is disposed so that at least a part of the accommodating portion 32a is overlapped with the process cartridge 30. In other words, the toner cartridge 32 and the process cartridge 30 are lined up in the first direction. In the present Embodiment, the first direction is a direction crossing a horizontal direction, and in particular, is the direction of gravity.

Incidentally, in the present Embodiment, an attaching and detaching direction of the process cartridge 30 with respect to the main assembly 1A is the direction of the rotational axis of the photosensitive drum 2 in the main assembly 1A. In addition, in the present Embodiment, an attaching and detaching direction of the toner cartridge 32 with respect to the main assembly 1A is the direction of the rotational axis of the photosensitive drum 2 in the main assembly 1A.

### Toner supplying passage

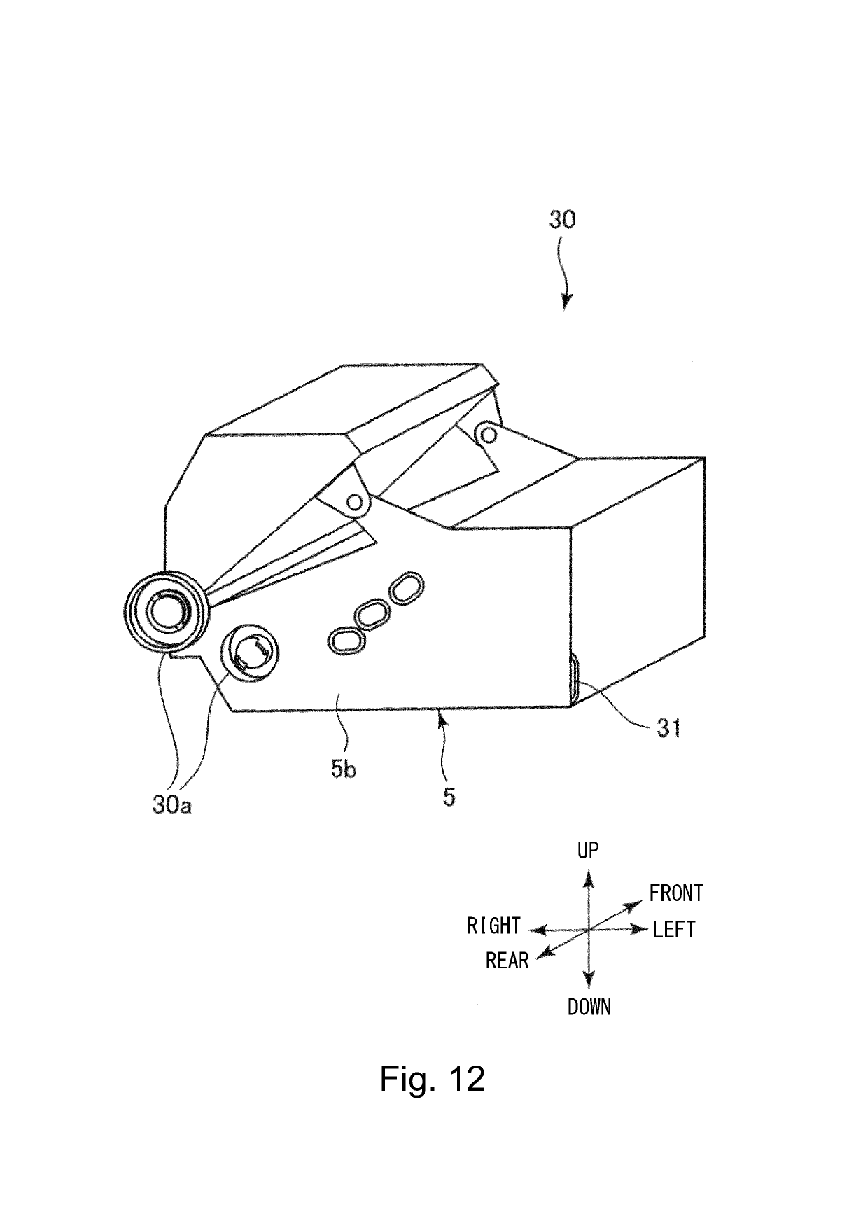

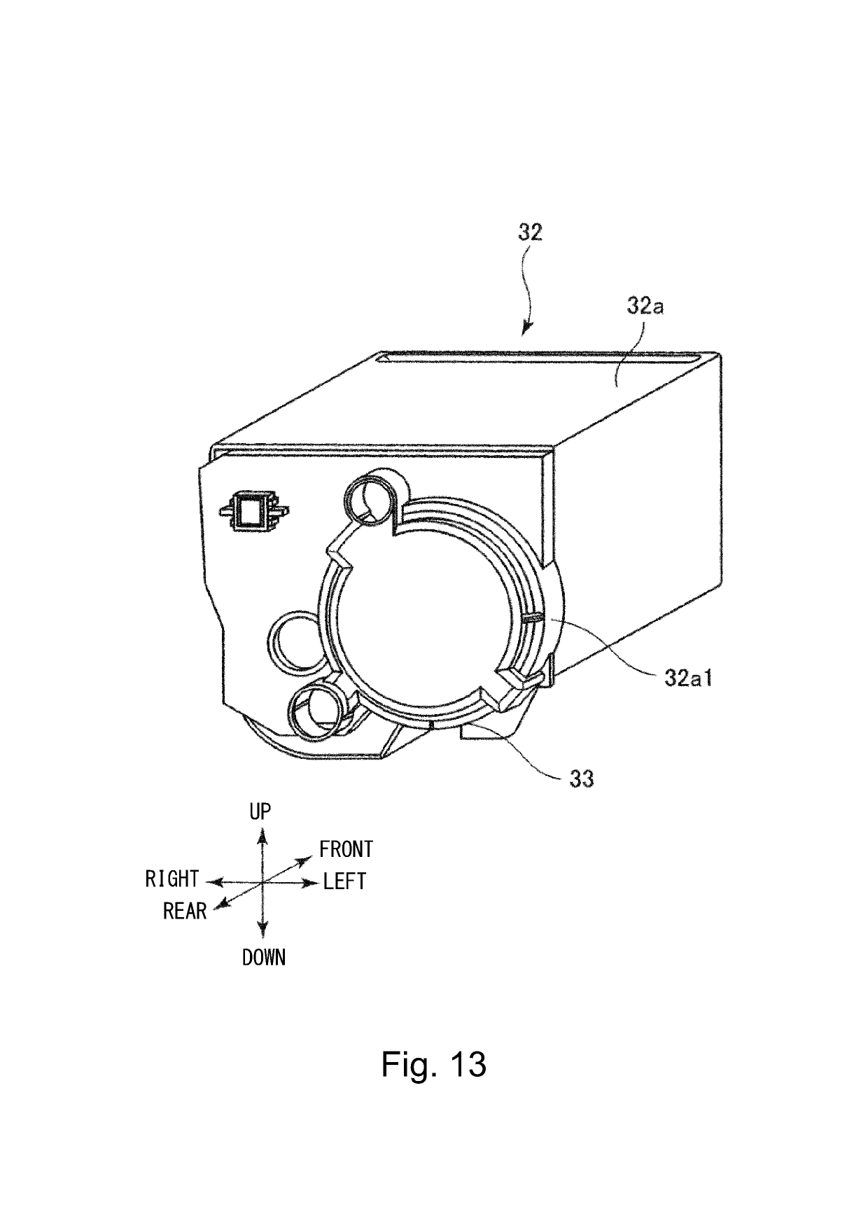

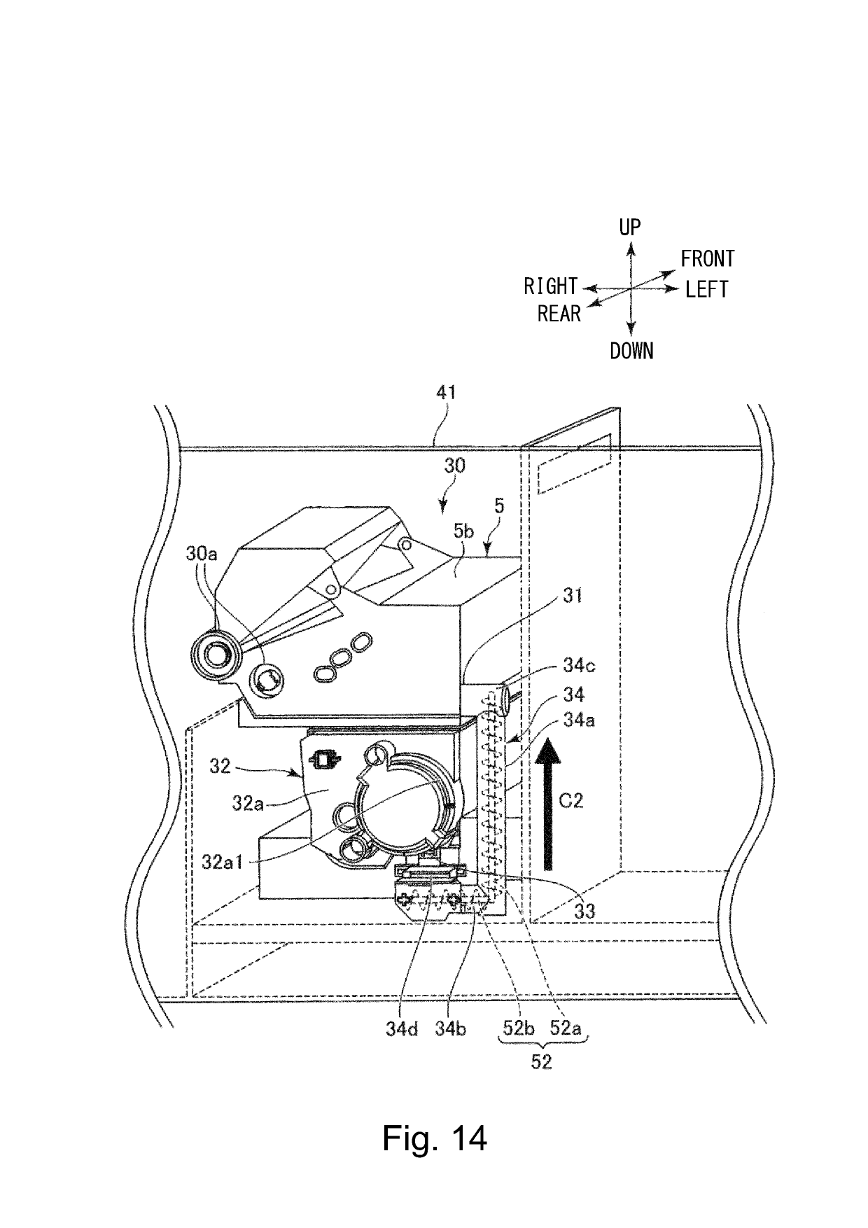

Next, a toner supplying passage from the toner cartridge 32 to the process cartridge 30 in the present Embodiment will be described. FIG. 12 is a perspective view of the process cartridge 30 in the present Embodiment. FIG. 13 is a perspective view of the toner cartridge 32 in the present Embodiment. FIG. 14 is a perspective view illustrating a toner conveyance pipe 34 which connects the toner cartridge 32 and the process cartridge 30 in the present Embodiment. FIG. 12 through FIG. 14 all illustrate states viewed from a back side (back side of a paper of FIG. 11) of the image forming apparatus 102.

As shown in FIG. 12, in the process cartridge 30, to an end portion on the back side thereof, a supply port 31, which is an opening portion for supplying the toner, is provided. In the present Embodiment, the supply port 31 is provided to a side portion on a left side in a most end portion on the back side of the process cartridge 30. The supply port 31 communicates with a space in a developing container 5b of a developing unit 5 in the process cartridge 30. In addition, in the present Embodiment, the supply port 31 opens toward the left side.

On the other hand, as shown in FIG. 13, in the toner cartridge 32, to an end portion on a back side thereof, a discharging port 33, which is an opening portion for discharging the toner, is provided. In the present Embodiment, the discharging port 33 is provided to a side portion on the back side of the toner cartridge 32. The discharging port 33 communicates with a space in the accommodating portion 32a of the toner cartridge 32. In the present Embodiment, the discharging port 33 is provided on a bottom surface side (downside) of the toner cartridge 32. In addition, in the present Embodiment, the discharging port 33 opens downward. In the present Embodiment, the accommodating portion 32a of the toner cartridge 32 includes, at an end portion on a back side thereof, a projecting portion 32a1 projected to the back side. In the present Embodiment, the discharging port 33 is provided on a bottom surface of this projecting portion 32a1. By the discharging port 33 being provided on the bottom surface side of the toner cartridge 32, it becomes possible to efficiently discharge the toner in the direction of gravity. Therefore, it is effective to fully discharge the toner in the toner cartridge 32.

And, as shown in FIG. 14, the supply port 31 of the process cartridge 31 is connected, via the toner conveyance pipe 34 provided to the main assembly 1A, to the discharging port 33 of the toner cartridge 32.

The toner conveyance pipe 34 is extended horizontally toward the left side from a portion connected to the discharging port 33, which is provided on the bottom surface side of the toner cartridge 32. In addition, the toner conveyance pipe 34 is extended, along (in the present Embodiment, in parallel with) the direction in which the toner cartridge 32 and the process cartridge 30 are lined up, toward the process cartridge 30 side passing through a left side of the toner cartridge 32. And, the toner conveyance pipe 34 is extended horizontally toward a right side toward the process cartridge 30 from an end portion of the portion extended toward the process cartridge 30 side, and is connected to the supply port 31 of the process cartridge 30.

To describe further, the toner conveyance pipe 34 includes a first part 34a extended along the conveyance direction D2 of the sheet S. In addition, the toner conveyance pipe 34 includes a second part 34b extended horizontally toward the discharging port 33 side of the toner cartridge 32 (right side) from an end portion of the first part 34a on the toner cartridge 32 side. In addition, the toner conveyance pipe 34 includes a third part 34c extended horizontally toward the supply port 31 side of the process cartridge 30 (right side) from an end portion of the first part 34a on the process cartridge 30 side. In addition, in the present Embodiment, to an end portion of the second part 34b on a side opposite to the first part 34a, a receiving portion 34d, which receives the toner discharged from the discharging port 33 of the toner cartridge 32, is provided. Incidentally, illustration is omitted for simplicity, however, in the present Embodiment, between the discharging port 33 and the receiving portion 34d, a sealing member, etc. for suppressing that the toner leaks from a gap between the discharging port 33 and the receiving portion 34d are provided. In addition, between the third part 34c and the supply port 31, a sealing member, etc. for suppressing that the toner leaks from a gap between the supply port 31 and the third part 34c may be provided.

And at least a part of the toner conveyance pipe 34 is provided, similarly to the Embodiment 1, as viewed in the second direction perpendicular to the rotational axis direction of the photosensitive drum 2 and perpendicular to the first direction, which is the direction in which the toner cartridge 32 and the process cartridge 30 are lined up, so as to be overlapped with the accommodating portion 32a of the toner cartridge 32. In particular, at least a part of the first part 34a of the toner conveyance pipe 34, which is extended between the toner cartridge 32 and the process cartridge 30 along the first direction, is overlapped with the accommodating portion 32a (particularly, the projecting portion 32a1) of the toner cartridge 32 as viewed in the second direction. In the present Embodiment, the second direction is a direction crossing the direction of gravity, and in particular, is the horizontal direction. In other words, in the present Embodiment, when the toner cartridge 32 is viewed from a left surface side thereof, at least a part of the toner conveyance pipe 34 is disposed at a position overlapped with the toner cartridge 32.

The toner conveyance pipe 34 is disposed on a front side of a backside plate 41, which is one of frame members of the main assembly 1A. The backside plate 41 is disposed, on a back side of the main assembly 1A, parallel to an up-down direction and a left-right direction, respectively (parallel to the paper of FIG. 11). Incidentally, in FIG. 14, the toner conveyance pipe 34, etc. are illustrated in a manner to be seen through a surface of the backside plate 41, and only a part of an edge of the backside plate 41 is illustrated.

At least a part of the toner conveyance pipe 34 is provided so as to be at the same position as the accommodating portion 32a of the toner cartridge 32 in the rotational axis direction of the photosensitive drum 2. In the present Embodiment, the toner conveyance pipe 34 is provided so that an approximately entirety thereof is overlapped with the accommodating portion 32a of the toner cartridge 32 in the rotational axis direction of the photosensitive drum 2.

In addition, the process cartridge 30 includes a driving force receiving portion 30a which receives a driving force from a drive transmitting portion 50 provided to the main assembly 1A, and transmits the driving force to a driven portion in the process cartridge 30. In the present Embodiment, at least a part of the toner conveyance pipe 34 is provided so as to be at the same position as the driving force receiving portion 30a in the rotational axis direction of the photosensitive drum 2. Furthermore, at least a part of the toner conveyance pipe 34 may be provided so as to be at the same position as the photosensitive drum 2 in the rotational axis direction of the photosensitive drum 2.

In addition, in the present Embodiment, at least a part of the toner conveyance pipe 34 is provided so as to be at the same position as a scanner unit 4 in the rotational axis direction of the photosensitive drum 2. In addition, in the present Embodiment, at least a part of the toner conveyance pipe 34 is provided so as to be at the same position as the cassette 13 in the rotational axis direction of the photosensitive drum 2. In addition, in the present Embodiment, at least a part of the toner conveyance pipe 34 is provided so as to be at the same position as a guide member 51 which regulates (guides) the moving direction of the sheet S. In addition, in the present Embodiment, at least a part of the toner conveyance pipe 34 is provided so as to be at the same position as a sheet conveying member such as a pulling-out roller 16 and a registration roller pair 17 which conveys the sheet S along the guide member 51.

Next, a conveyance passage of the toner will be described. The toner is conveyed from the toner cartridge 32 toward the process cartridge 30 through the toner conveyance pipe 34, and is supplied to the process cartridge 30. Specifically, first, the toner in the toner cartridge 32 is discharged from the discharging port 33, and sent into the toner conveyance pipe 34. In the present Embodiment, the toner falls by utilizing gravity through the discharging port 33, and is moved to the receiving portion 34d of the toner conveyance pipe 34. Inside the first part 34a and the second part 34b of the toner conveyance pipe 34, a screw 52 which is a toner conveyance member as a toner conveyance means is disposed. A first screw 52a is disposed inside the first part 34a, and a second screw 52b is disposed inside the second part 34b. The screw 52 (52a, 52b) is driven by a driving unit (not shown) as a driving means, which is provided to the main assembly 1A. The toner which has been moved to the receiving portion 34d is conveyed, by the second screw 52b being driven, inside the second part 34b of the toner conveyance pipe 34, to the left side toward the first part 34a of the toner conveyance pipe 34. In addition, the toner inside the first part 34a of the toner conveyance pipe 34 is conveyed, by the first screw 52a being driven, upward in a direction of an arrow C2 in FIG. 14. This direction of the arrow C2 is the direction along (in the present Embodiment, the direction parallel to) the conveyance direction D2 of the sheet S. The toner, which has been conveyed inside the first part 34a of the toner conveyance pipe 34 by the first screw 52a, is conveyed to the right side toward the supply port 31 of the process cartridge 30 inside the third part 34c of the toner conveyance pipe 34. Incidentally, in the present Embodiment, the toner inside the third part 34c is conveyed in a manner of being pushed by the toner, which has been moved inside the first part 34a, however, a toner conveying member such as a screw may be provided also inside the third part 34c. And the toner, which has been conveyed inside the third part 34c of the toner conveyance pipe 34, enters an inside of the developing container 5b of the developing unit 5 through the supply port 31. In this manner, the toner is supplied from the toner cartridge 32 to the process cartridge 30.

In the present Embodiment, the process cartridge 30 and the toner cartridge 32 are lined up along the conveyance direction D2 of the sheet S, and the toner conveyance pipe 34 (particularly, the first part 34a) is disposed so as to be overlapped with the left side of the toner cartridge 32. By this, a space for providing the toner conveyance pipe 34 in the main assembly 1A on the back side of the toner cartridge 32 is not required. Therefore, it becomes possible to reduce the space, and achieve downsizing of the image forming apparatus 102. Alternatively, since it becomes possible to use the space for the toner cartridge 32, a toner capacity of the toner cartridge may be increased.

In addition, in the present Embodiment, the toner conveyance pipe 34 is disposed on the front side of the backside plate 41. By this, it becomes possible to access the toner conveyance pipe 34 from a front side of the image forming apparatus 102, and it becomes possible to improve maintainability. For example, as described in the Embodiment 1, in a case in which the toner conveyance pipe 34 is configured to be replaceable as a unit, unit replacement thereof becomes easy.

Incidentally, the arrangement of the process cartridge 30 and the toner cartridge 32 may be changed as appropriate. For example, the order in which the toner cartridge 32 and the process cartridge 30 are lined up in the conveyance direction D2 of the sheet S may be switched. In addition, the toner cartridge 32 and the process cartridge 30 are not limited to be lined up in parallel with the conveyance direction D2 of the sheet S, but may be disposed so as to be inclined to the conveyance direction D2 of the sheet S.

In addition, also in the present Embodiment, similarly to a modification described as the Modified Example to the Embodiment 1, the toner conveyance means is not limited to the screw member, but may be changed as appropriate.

### Embodiment 4

Next, another Embodiment of the present invention will be described. Basic configuration and operation of an image forming apparatus in the present Embodiment are the same as those in the Embodiment 3. Therefore, in the image forming apparatus in the present Embodiment, to those elements having functions or configurations which are the same as or corresponding to those of the image forming apparatus in the Embodiment 3, the same reference numerals as in the Embodiment 3 will be attached, and detailed description thereof will be omitted.

### Arrangement of cartridges

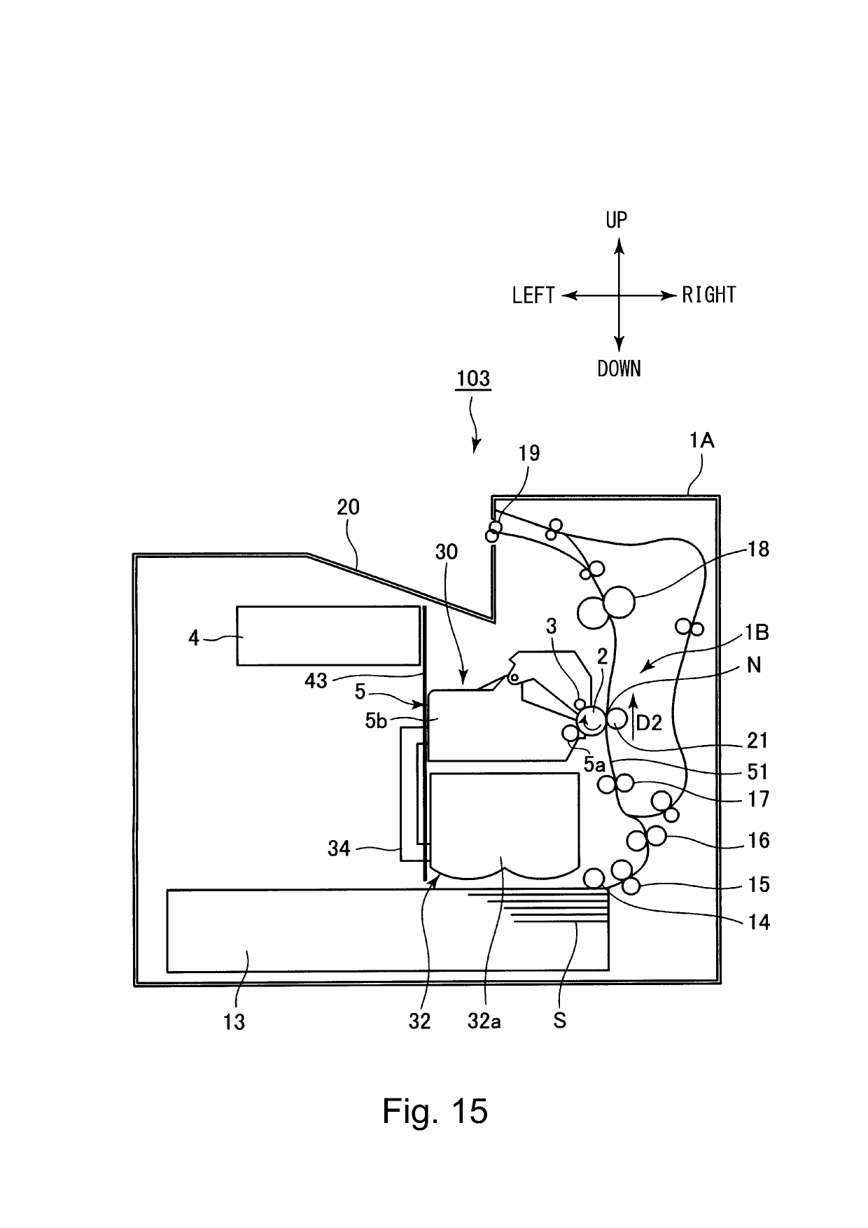

Arrangement of a process cartridge 30 and a toner cartridge 32 in the present Embodiment will be described. FIG. 15 is a cross-sectional outline view of an image forming apparatus 103 in the present Embodiment.

As shown in FIG. 15, in the present Embodiment, similarly to the Embodiment 3, the process cartridge 30 and the toner cartridge 32 are lined up along (in the present Embodiment, in parallel with) a conveyance direction D2 of a sheet S and on a left side with respect to a transfer roller 21. In addition, in the present Embodiment, similarly to the Embodiment 3, the toner cartridge 32 is disposed on an upstream side in the conveyance direction D2 of the sheet S with respect to the process cartridge 30. And, in the present Embodiment, similarly to the Embodiment 3, at least a part of an accommodating portion 32a of the toner cartridge 32 is, as viewed in the conveyance direction D2 of the sheet S, overlapped with the process cartridge 30.

### Toner supplying passage

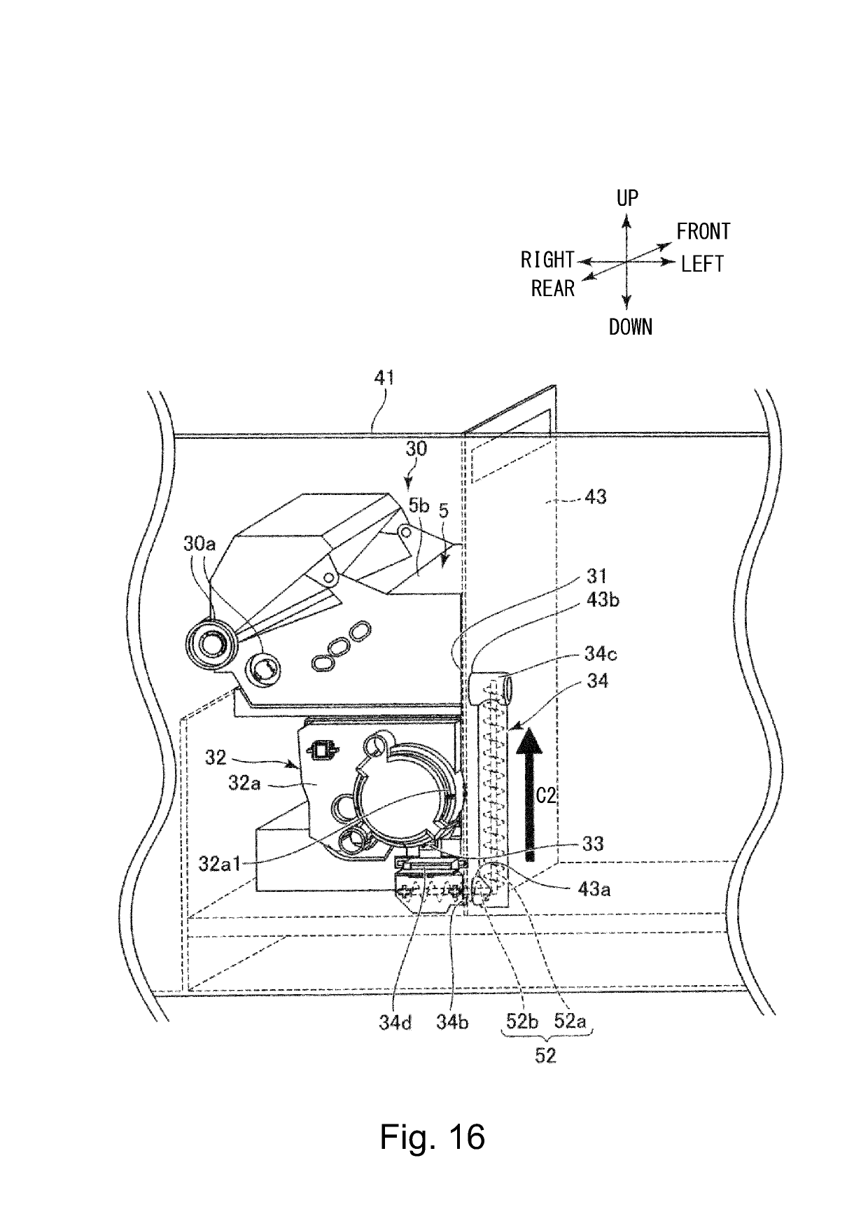

Next, a toner supplying passage from the toner cartridge 32 to the process cartridge 30 in the present Embodiment will be described. FIG. 16 is a perspective view illustrating the toner conveyance pipe 34 which connects the toner cartridge 32 and the process cartridge 30. FIG. 16 illustrates a state as viewed from a back side of the image forming apparatus 103 (back side of a paper of FIG. 15).

As shown in FIG. 16, in the present Embodiment, similarly to the Embodiment 3, the process cartridge 30 is provided with a supply port 31 at an end portion on a back side thereof. In addition, in the toner cartridge 32, on a bottom surface side of an end portion on a back side thereof, a discharging port 33 is provided. And the supply port 31 of the process cartridge 30 is connected, via a toner conveyance pipe 34 provided to a main assembly 1A, to the discharging port 33 of the toner cartridge 32.

In the present Embodiment, similarly to the Embodiment 3, the toner conveyance pipe 34 includes a first part 34a, a second part 34b, and a third part 34c. In addition, in the present Embodiment, to the toner conveyance pipe 34, a receiving portion 34d is provided.

And similarly to the Embodiment 3, as viewed in the second direction perpendicular to the rotational axis direction of the photosensitive drum 2 and perpendicular to the first direction, which is the direction in which the toner cartridge 32 and the process cartridge 30 are lined up, at least a part of the toner conveyance pipe 34 is provided so as to be overlapped with the accommodating portion 32a of the toner cartridge 32. In particular, at least a part of the first part 34a of the toner conveyance pipe 34 is overlapped with the accommodating portion 32a (particularly, a projecting portion 32a1) of the toner cartridge 32 as viewed in the second direction. In the present Embodiment, the second direction is a direction crossing a direction of gravity, and in particular, is a horizontal direction.

In the present Embodiment, at least a part of the toner conveyance pipe 34 is disposed on an opposite side to the process cartridge 30 and the toner cartridge 32 across a cartridge stay 43, which is one of frame members of the main assembly 1A. The cartridge stay 43 is a frame which supports the process cartridge 30 and the toner cartridge 32, and is disposed parallel to an up-down direction and a front-back direction, respectively (perpendicular to the paper of FIG. 15). In addition, in the present Embodiment, at least a part of the toner conveyance pipe 34 is attached to the cartridge stay 43.

In other words, in the present Embodiment, the first part 34a of the toner conveyance pipe 34 is disposed on a left side of the cartridge stay 43, and is attached to the cartridge stay 43. In addition, in the present Embodiment, the second part 34b of the toner conveyance pipe 34 is disposed on a right side of the cartridge stay 43, and is attached to the cartridge stay 43. In addition, in the present Embodiment, the third part 34c of the toner conveyance pipe 34 is disposed on the right side of the cartridge stay 43, and is attached to the cartridge stay 43. And, the first part 34a and the second part 34b communicate with each other via a first hole 43a, which is a hole (opening portion) provided in the cartridge stay 43. In other words, the first part 34a is attached to the left side of the cartridge stay 43 so as to be connected to the first hole 43a, and the second part 34b is attached to the right side of the cartridge stay 43 so as to be connected to the first hole 43a. As a result, the discharging port 33 of the toner cartridge 32 and the first part 34a of the toner conveyance pipe 34 are connected by the second part 34b of the toner conveyance pipe 34, which is extended to the right side from the first hole 43a of the cartridge stay 43. Similarly, the first part 34a and the third part 34c communicate with each other via a second hole 43b, which is a hole (opening portion) provided in the cartridge stay 43. In other words, the first part 34a is attached to the left side of the cartridge stay 43 so as to be connected to the second hole 43b, and the third part 34c is attached to the right side of the cartridge stay 43 so as to be connected to the second hole 43b. As a result, the supply port 31 of the process cartridge 30 and the first part 34a of the toner conveyance pipe 34 are connected by the third part 34c of the toner conveyance pipe 34, which is extended to the right side from the second hole 43b of the cartridge stay 43. Here, the second part 34b of the toner conveyance pipe 34 may be considered to be configured to include the first hole 43a provided in the cartridge stay 43. In addition, the third part 34c of the toner conveyance pipe 34 may be considered to be configured to include the second hole 43b provided in the cartridge stay 43.

Incidentally, it may be configured that the second part 34b of the toner conveyance pipe 34 is connected, in a manner that the second part 34b is extended and penetrates the first hole 43a provided in the cartridge stay 43, to the discharging port 33 of the toner cartridge 32 and the first part 34a of the toner conveyance pipe 34. Similarly, it may be configured that the third part 34c of the toner conveyance pipe 34 may be connected, in a manner that the third part 34c is extended and penetrates the second hole 43b provided in the cartridge stay 43, to the first part 34a of the toner conveyance pipe 34 and the supply port 31 of the process cartridge 30.

In this manner, in the present Embodiment, the toner conveyance pipe 34 is extended horizontally from a portion connected to the discharging port 33, which is provided on the bottom surface side of the toner cartridge 32, up to the left side of the cartridge stay 43. In addition, the toner conveyance pipe 34 is extended toward the process cartridge 30 side passing through the left side of the cartridge stay 43 along (in the present Embodiment, in parallel with) the direction in which the toner cartridge 32 and the process cartridge 30 are lined up. And the toner conveyance pipe 34 is extended horizontally toward the process cartridge 30 up to the right side of the cartridge stay 43 from an end portion of the portion extended toward the process cartridge 30 side, and is connected to the supply port 31 of the process cartridge 30.

In addition, in the present Embodiment, similarly to the Embodiment 3, the toner conveyance pipe 34 is disposed on a front side of a backside plate 41.

A conveyance passage of toner in the present Embodiment is similar to that in the Embodiment 3. In other words, in the present Embodiment, similarly to the Embodiment 3, the toner is discharged from the discharging port 33 of the toner cartridge 32. This toner is conveyed, inside the second part 34b of the toner conveyance pipe 34, by a second screw 52b, to the left side toward the first part 34a of the toner conveyance pipe 34. The toner inside the first part 34a of the toner conveyance pipe 34 is conveyed upward in a direction of an arrow C2 in FIG. 16 by a first screw 52a. This direction of the arrow C2 is the direction along (in the present Embodiment, the direction parallel to) the conveyance direction D2 of the sheet S. In addition, the toner, which has been conveyed inside the first part 34a of the toner conveyance pipe 34, is conveyed to the right side toward the supply port 31 of the process cartridge 30 inside the third part 34c of the toner conveyance pipe 34. Thereafter, the toner enters an inside of a developing container 5b of a developing unit 5 through the supply port 31. In this manner, the toner is supplied from the toner cartridge 32 to the process cartridge 30.

In the present Embodiment, the process cartridge 30 and the toner cartridge 32 are lined up along the conveyance direction D2 of the sheet S, and the toner conveyance pipe 34 (particularly, the first part 34a) is disposed so as to be overlapped with the left side of the toner cartridge 32. By this, it becomes possible to obtain an effect similar to the Embodiment 3.

In addition, in the present Embodiment, the toner conveyance pipe 34 (particularly, the first part 34a) is disposed on the opposite side to the process cartridge 30 and the toner cartridge 32 across the cartridge stay 43 (the left side of the cartridge stay 43). As a result, the toner conveyance pipe 34 is in an area different from an area where the process cartridge 30 and the toner cartridge 32 are provided. Therefore, it becomes possible to easily access the toner conveyance pipe 34 (particularly, the first part 34a) from the front side of the image forming apparatus 103 without pulling out the process cartridge 30 and/or the toner cartridge 32 from the main assembly 1A, and it becomes possible to improve maintainability. For example, as described in the Embodiment 1, in a case in which the toner conveyance pipe 34 is configured to be replaceable as a unit, unit replacement thereof becomes easy.

In addition, in the present Embodiment, the toner conveyance pipe 34 is attached to the cartridge stay 43, which supports the process cartridge 30 and the toner cartridge 32. In other words, in the present Embodiment, the toner conveyance pipe 34 is attached to a component common to the process cartridge 30 and the toner cartridge 32. By this, since it becomes possible to reduce dimensions related to the connections between the supply port 31 of the process cartridge 30 and the discharging port 33 of the toner cartridge 32 and the toner conveyance pipe 34, and reduce tolerance variation, it becomes possible to improve accuracy in connected positions.

Incidentally, also in the present Embodiment, as described in the Embodiment 3, the arrangement of the process cartridge 30 and the toner cartridge 32 and the toner conveyance means may be changed as appropriate.

### Others

As described above, the present invention has been described according to the specific Embodiments, however, the present invention is not limited to the Embodiments described above.

In the Embodiments described above, the image forming apparatus is configured to include one process cartridge and one toner cartridge, however, the numbers of the process cartridge and the toner cartridge may be changed. For example, the image forming apparatus may be configured to include two process cartridges and two toner cartridges. In addition, for example, the image forming apparatus may be a color image forming apparatus which includes four process cartridges. In addition, the toner cartridge may be provided for at least one of a plurality of the process cartridges which the image forming apparatus includes. And the present invention may be applied to a toner supplying passage from the toner cartridge to the process cartridge.

In addition, in the Embodiments described above, the developer used by the developing unit is the one-component developer, however, it is not limited thereto, but may be a two-component developer which includes toner and carrier. In that case, a supplied agent to be supplied from a toner cartridge to a developing unit may include the toner and the carrier.

In addition, in the Embodiments described above, the attaching and detaching direction of the process cartridge, the toner cartridge, and the cassette with respect to the main assembly is a direction parallel to the rotational axis direction of the photosensitive drum in the main assembly. However, the attaching and detaching direction of the process cartridge, the toner cartridge, and the cassette with respect to the main assembly is not limited thereto, but may be a direction crossing (for example, a direction perpendicular to) the rotational axis direction of the photosensitive drum in the main assembly, respectively.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-073790, filed April 26, 2025, which is hereby incorporated by reference herein in its entirety.

What is claimed is:

1. An image forming apparatus for forming an image on a sheet, the image forming apparatus comprising:
a main assembly;
a process cartridge detachably mountable to the main assembly and provided with a photosensitive drum rotatable about a rotational axis thereof and a developing unit configured to supply toner to the photosensitive drum and to form a toner image on the photosensitive drum;
a toner cartridge detachably mountable to the main assembly independently from the process cartridge and provided with an accommodating portion configured to accommodate the toner; and
a passage configured to communicate with both the process cartridge and the toner cartridge, through which the toner supplied from the toner cartridge to the developing unit passes,
wherein as viewed in a first direction perpendicular to the rotational axis, the toner cartridge is disposed so that at least a part of the accommodating portion is overlapped with the process cartridge, and
wherein as viewed in a second direction perpendicular to the rotational axis and perpendicular to the first direction, at least a part of the passage is provided so as to be overlapped with the accommodating portion.

2. The image forming apparatus according to claim 1, wherein the toner cartridge includes a discharging portion configured to discharge the toner accommodated in the accommodating portion from the accommodating portion,
wherein the process cartridge includes a receiving portion configured to receive the toner which has passed through the passage into the developing unit,
wherein the passage includes a first part extending between the toner cartridge and the process cartridge along the first direction, a second part connecting the first part and the discharging portion and a third part connecting the first part and the receiving portion, and
wherein as viewed in the second direction, at least a part of the first part of the passage is provided so as to be overlapped with the accommodating portion.

3. The image forming apparatus according to claim 2, wherein the discharging portion is provided so that the toner is moved from the accommodating portion to the passage through the discharging portion by gravity.

4. The image forming apparatus according to claim 1, further comprising an endless belt configured to form a transfer portion in contact with the photosensitive drum and onto which the toner image is transferred from the photosensitive drum at the transfer portion.

5. The image forming apparatus according to claim 4, wherein the process cartridge and the toner cartridge are disposed below the belt.

6. The image forming apparatus according to claim 1, wherein the first direction is a direction crossing a direction of gravity.

7. The image forming apparatus according to claim 1, further comprising a transfer member configured to form a transfer portion in contact with the photosensitive drum and to transfer the toner image from the photosensitive drum onto the sheet passing through the transfer portion.

8. The image forming apparatus according to claim 1, wherein the first direction is a direction crossing a horizontal direction.

9. The image forming apparatus according to claim 1, wherein the main assembly includes a frame member, and
wherein at least the part of the passage is provided on a side opposite to a side where the process cartridge and the toner cartridge are provided with respect to the frame member.

10. The image forming apparatus according to claim 9, wherein the toner cartridge includes a discharging portion configured to discharge the toner accommodated in the accommodating portion from the accommodating portion,
wherein the process cartridge includes a receiving portion configured to receive the toner which has passed through the passage into the developing unit,
wherein the passage includes a first part extending between the toner cartridge and the process cartridge along the first direction, a second part connecting the first part and the discharging portion and a third part connecting the first part and the receiving portion, and
wherein the first part is positioned on the side opposite to the side where the process cartridge and the toner cartridge are provided with respect to the frame member.

11. The image forming apparatus according to claim 10, wherein the second part is positioned on the side where the process cartridge and the toner cartridge are provided with respect to the frame member, and
wherein at least the part of the first part is connected to the second part through a first opening portion provided on the frame member.

12. The image forming apparatus according to claim 10, wherein the third part is positioned on the side where the process cartridge and the toner cartridge are provided with respect to the frame member, and
wherein the first part is connected to the third part through a second opening portion provided on the frame member.

13. The image forming apparatus according to claim 10, wherein the frame member supports the process cartridge, the toner cartridge and the passage.

14. The image forming apparatus according to claim 1, wherein a mounting direction of the process cartridge to the main assembly is a direction of the rotational axis.

15. The image forming apparatus according to claim 1, wherein a mounting direction of the toner cartridge to the main assembly is a direction of the rotational axis.

16. The image forming apparatus according to claim 14, wherein the main assembly includes a frame member provided on a downstream side of the main assembly in the mounting direction, and
wherein the passage is provided on an upstream side of the frame member in the mounting direction.

17. The image forming apparatus according to claim 1, wherein the main assembly includes a drive transmitting portion configured to transmit a driving force to the process cartridge,
wherein the process cartridge includes a driving force receiving portion configured to receive the driving force in engagement with the drive transmitting portion, and
wherein as viewed in the second direction, at least the part of the passage is provided so as to be overlapped with the driving force receiving portion.

18. The image forming apparatus according to claim 1, wherein at least the part of the passage is provided at the same position as the photosensitive drum in a direction of the rotational axis.

19. The image forming apparatus according to claim 1, wherein the main assembly includes an exposing unit configured to expose the photosensitive drum and to form an electrostatic latent image on the photosensitive drum, and
wherein as viewed in the second direction, at least a part of the passage is provided so as to be overlapped with the exposing unit.

20. The image forming apparatus according to claim 1, wherein the main assembly provided with a sheet accommodating portion configured to accommodate the sheet onto which the toner image formed on the photosensitive drum is transferred, and
wherein as viewed in the second direction, at least the part of the passage is provided so as to be overlapped with the sheet accommodating portion.

21. The image forming apparatus according to claim 1, wherein the main assembly includes a guide member configured to guide the sheet onto which the toner image formed on the photosensitive drum is transferred, and
wherein at least the part of the passage is provided at the same position as the guide member in a direction of the rotational axis.

22. The image forming apparatus according to claim 1, wherein the main assembly includes a sheet conveyance member configured to convey the sheet onto which the toner image formed on the photosensitive drum is transferred, and
wherein at least the part of the passage is provided at the same position as the sheet conveyance member in a direction of the rotational axis.

23. The image forming apparatus according to claim 1, further comprising a conveyance member configured to convey the toner inside the passage.

24. The image forming apparatus according to claim 23, wherein the conveyance member is at least one of a screw, a belt and a paddle.

25. The image forming apparatus according to claim 1, further comprising a conveyance mechanism configured to convey the toner inside the passage by air pressure.
